(19) United States
(12) Patent Application Publication
(10) Pub. No.: US 2003/0027547 A1
(43) Pub. Date: Feb. 6, 2003

(54) Emergency communication system

(76) Inventor: Gerald Wade, India Atlantic, FL (US)

Correspondence Address: ROGER A JACKSON, ESQ, 16430 WEST ELLSWORTH AVENUE, GOLDEN, CO, 80401-6545, US

(21) Appl. No.: 09/682,056

(22) Filed: Jul. 16, 2001

(51) Int. Cl. H04M 11/00

(52) U.S. Cl. 455/404; 455/550

(57) ABSTRACT

An improved emergency communications system which provides voice communication between an emergency caller 27 and the 911 emergency response operator 28 through either a base station unit 38 or a wireless remote personal pendant 40. The system has the capability of automatically dialing the emergency phone number and can provide verification of system initialization by the use 1-800 phone numbers without the need of contacting 911 emergency operators 28. The system includes a wireless pendent 40 with automatic dialing call and voice capability that is in radio frequency communication with a base unit 38, wherein the base unit 38 can have automatic dialing call and voice capability to communicate over existing phone lines 29 to the 911 emergency response operator 28.

### TECHNICAL FIELD

The present invention generally relates to an emergency communication system. More particularly, this invention relates to a system that interconnects with the 911 telephone emergency network and permits automatic dialing of the emergency 911 number and establishes voice communication between the emergency caller and a 911 emergency response operator. In addition, emergency calls can be initiated at a base station or by a miniature wireless remote radio frequency transmitter pendant that is always worn by the caller. Voice communication between the emergency caller and the and 911 emergency response operator may be established either through the base station speakerphone or the pendant microphone directly.

### BACKGROUND OF INVENTION

Currently, with the aging demographics in the United States, and a preference for smaller household sizes that creates a higher likelihood of an individual being alone or unaccompanied, along with a higher percentage of children home alone, security and emergency response products have been in high demand to serve the above identified groups. Along with this, the advances in electronics technology have allowed the creation of products that can better serve this demand. A number systems are known in the prior art which are designed to provide emergency dialing capabilities to third-party central monitoring services. These central monitoring services establish voice or alarm communications first with the user, and secondly to notify the appropriate authorities, such as police, fire, ambulance, poison control, etc., on behalf of the caller. These systems were particularly useful because they provided the original 911 emergency services with a clearing house service and screening capability for the above mentioned authorities. The third party central monitoring service responding operators make judgments based on the information provided by the emergency caller or based on silent alarms, about which the authority to notify on behalf of the user.

There are a number of drawbacks to the third party central monitoring service, such as the ongoing fees that typically an individual must pay, including a sign up fee and then an ongoing fee of between $30 and $50 per month in monitoring fees. In addition, the customer must usually agree to a long-term contract of typically two years to five years in duration resulting in a total investment of approximately $2,000. At the expiration of the contract term the customer must renew the contract to keep the third party monitoring service active. A problem with the third-party monitoring service is the extra communication link that delays making a quick emergency response. The process by which an emergency call was made to a third-party monitoring service results in the monitoring service making a return call to the emergency caller in an attempt to verify the emergency situation. This activity may prove futile if the emergency caller is incapacitated in some manner and cannot respond to the return call from the third-party monitoring service. This situation requires that the third-party monitoring service call a second or first alternate number that was listed as an alternative contact number by the emergency caller when they signed up for the service. If the third-party monitoring service is successful in contacting a person on the alternate number they are asked to confirm the emergency initiated by the original of caller. If this first alternate number results in no one being able to be contacted then a third alternate number is called to again verify confirmation of the emergency initiated by the original caller. Absent making contact with the second alternate number the third-party monitoring service will call emergency services and dispatch help to the original emergency caller. It can be observed from the process that the situation can occur where critical time is wasted in getting emergency help to the original emergency caller. Statistically, the emergency dispatch time from the 911 emergency call utilizing a third-party monitoring service typically has a 35 minute response time from the time that the caller places the emergency call until the emergency response team is proceeding to the emergency caller's location. This is as compared to an emergency dispatch time from the 911 emergency call not utilizing a third-party monitoring service typically has 8 minute response time from the time that the emergency caller places the emergency call until the emergency response team is proceeding to the emergency caller's location. Also, these third party central monitoring service responding operators are frequently located remotely from the caller, being hundreds or even thousands of miles away further increasing the risk of national telecommunications problems interfering with the emergency communications system. In addition, it is a common practice of these third party central monitoring service responding operators to demonstrate system viability by periodically calling the caller to ask for a test of the emergency dialing system. This callback service, although effective in verifying the emergency communication system operation, does require an additional staff and costs to implement as opposed to an automated testing system.

Current enhanced 911 services, are able to determine the address location and name or identity of the emergency caller thereby eliminating the need for the third party service to provide this information. Also, enhanced 911 service provides dispatch for all emergency services in the community. These include not only the above mentioned police, fire, ambulance, poison control, but also utilities emergencies, adverse weather, and other natural or man-made disasters as well. With the use of the current enhanced 911 service, a third party monitoring service simply adds another cumbersome communication layer and the resulting time delays and uncertainty to the overall 911 emergency services communication process.

There are typically two critical issues in an emergency situation, the first one is time, being the time for communication from the injured party or from an individual with or near the injured party to the appropriate emergency service is critical, as this time of necessity must absolutely be minimized. The second critical issue occurs in a situation where the injured party may be unaccompanied or unattended and is in a situation where they are incapacitated from either an injury, poisoning or the like. In this situation the injured party may not be able to access the telephone to make the emergency call for help, and would require a remote access device to enable making the emergency call for help.

A further ancillary issue to the above two issues concerns the psychological state of the individual making the emergency call, as this is normally a stressful situation, wherein the caller may not be able to think clearly, which requires that the required emergency communications process be as short and simple as possible.

In addition, in existing emergency dialer systems, voice communication using only the speaker phone limits voice communication to the near vicinity of the speakerphone. If the emergency occurs in another room separate from the location of the speaker phone, the 911 operator will have little chance of hearing the users verbal call for help. This will be particularly true if there is the presence of ambient residual noise such as radio or television in the background further interfering with the victims' calls for help.

There remains a need for an emergency communications system that has the capability of making automatic emergency calls with or without voice communication from either a desktop base unit or from a hand-held personal pendant device that is remote to the base unit directly to the 911 emergency operator without the need and ongoing cost for a third-party monitoring service function that acts to hinder the effectiveness of the 911 emergency communications system.

A desired emergency communications system would only have a one-time up front purchase price for the product and would not have any ongoing or continuing monthly fees requiring a separate contract to be burdened with by the individual purchasing the system, thus resulting in a much lower cost to the purchaser over time.

### SUMMARY OF INVENTION

It is an object of the present invention to provide an improved emergency communications system which permits automatic dialing of the emergency 911 number from either a base unit or a radio frequency wireless remote personal pendant.

Yet another object of the present invention is to eliminate the need for a third party monitoring service for 911 emergency calls.

It is a further object of the present invention to provide activation of the automatic dialer by either pressing a button on the base unit or a button on the radio frequency wireless remote personal pendant.

Still another object of the present invention is to provide emergency caller verbal communication directly with the emergency 911 emergency response operator using a personal pendent microphone or a base unit microphone.

It is yet another object of the present to provide a voice activated wireless remote personal pendant to allow a clerk who is a robbery victim in a retail establishment to automatically make the 911 emergency call using a specific discrete verbal command and allow the 911 emergency response operator to monitor the conversation between the clerk and the criminal perpetrator.

Yet another object of the present invention is to provide a 911 emergency response operator voice response through the base unit speaker phone.

It is another object of the present invention to provide an initial installation test and verification of operation using automatically dialed 1-800 numbers to avoid unnecessary calls to 911 emergency response operators.

It is yet another object of the present invention to require multiple consecutive activation signals by the emergency caller to eliminate inadvertent or accidental calls to the 911 emergency response operator.

It is further yet another object of the present invention to provide a an override intervention by generating signals to disconnect other off hook calls on the emergency phone line to allow the emergency call to be made.

It is further yet still another object of the present invention to provide automatic learning of the low frequency transmission address codes from the personal remote pendent to simplify the manufacturing and setup process.

Yet another object of the present invention is to provide a more affordable emergency communication system for the consumer by eliminating the third-party monitoring service set up fee and ongoing monthly fees.

The present invention is an improved emergency communications system for communicating between an emergency caller and an emergency response operator. The system comprises two basic parts, the first part is a portable self-contained wireless remote personal pendant and the second part is a base unit.

The portable self-contained wireless remote control pendant includes a radio frequency transmitter for transmitting the valid signal to the base unit and a low frequency encoder that is connected to the transmitter being operative to generate a valid signal for the pendant. The pendant also includes circuitry to distribute operational commands to the transmitter and the encoder and includes a self-contained electrical power supply that is in electrical communication with the pendent circuitry. The pendent has a momentary switch that is connected to the pendent circuitry that is activated by the emergency caller to energize the pendent circuitry, a microphone is also coupled with the pendent circuitry and is operative to send voice communications from the emergency caller through the pendant transmitter to the receiver in the base to eventually be audibly received by the emergency response operator.

The base unit includes a radio frequency receiver for receiving a signal, having a low frequency decoder that is connected to the radio frequency receiver and that is operative to determine the validity of the receiver signal. The base unit also includes circuitry with a central processing unit that receives a communication from the low frequency decoder when a valid receiver signal is present. When a valid receiver signal is present the central processing unit has stored in memory at least one emergency telephone number and is operative to generate a control signal upon receipt of the valid receiver signal. This control signal is sent to a dial tone generator that is operative in response to the control signal from the central processing unit to generate a sequence of tones corresponding to the stored emergency telephone number in the central processing unit. In addition, the base unit circuitry has the capability of processing the voice signal transmitted from the pendant and subsequently transmitting the voice signal to the emergency response operator. A telephone interface circuit is operative to connect to the dial tone generator to the telephone line for the purpose of completing the emergency communication from the emergency caller to the emergency response operator.

These and other objects of the present invention will become more readily appreciated and understood from a consideration of the following detailed description of an embodiment of the present invention when taken together with the accompanying drawings, in which:

### BRIEF DESCRIPTION OF DRAWINGS

FIG. 1 is a block diagram of the local or household typical prior art emergency communications system, showing the wireless pendant, the base unit, and the connection to the third-party monitoring service company;

FIG. 2 is a block diagram of the entire typical prior art emergency communications system, showing the emergency caller user phone, the third party monitoring service company, the 911 emergency response operator and the typical authorities contacted by the 911 emergency response operator;

FIG. 3 is a block diagram of the an embodiment of the present invention with the emergency caller being directly connected to the 911 emergency response operator and the typical authorities contacted by the 911 emergency response operator;

FIG. 4 is a block diagram of an embodiment of the present invention, with the radio frequency wireless remote pendant, the base unit, and the direct link to the 911 emergency response operator;

FIG. 5 is a composite diagram of an embodiment of the present invention in use with the emergency caller using the radio frequency wireless remote pendant;

FIG. 6 is a perspective view of the base unit housing;

FIG. 7 is a perspective view of the pendent housing;

FIG. 8 is a summary schematic circuit block diagram for the personal remote pendant;

FIGS. 9, 10, 11, and 12 are interconnect schematic circuit diagrams for the personal remote pendant;

FIG. 13 is a summary schematic circuit block diagram for the base unit;

FIGS. 14, 15, 16, 17, 18, 19, 20, 21, 22, 23, 24, and 25 are interconnect schematic circuit diagrams for the base unit;

FIG. 26 is a flow chart illustrating diagrammatically the initialization process for the pendant and base; and

FIG. 27 is a flow chart illustrating diagrammatically the process for making an emergency communication utilizing the pendant or base.

### REFERENCE NUMBERS IN DRAWINGS

Elements

22 Prior art pendant

24 Prior art base unit

26 Prior art third-party monitoring service

27 Emergency caller

28 Emergency 911 response operator and dispatcher

29 Telephone line

30 Police

32 Ambulance

34 Fire

36 Poison control

38 Base unit assembly

40 Pendant assembly

41 Pendent housing 42

Base unit housing 44

Base unit indicia

45 Pendent indicia

46 Pendant battery

47 Pendent belt clip

48 Pendant slide switch

49 Pendent necklace, bracelet, key chain, and pocket chain

50 Pendent push button

51 Pendent valid radio frequency signal

52 Pendent power on latch

54 Pendant perceptible output

55 Pendent microphone

56 Pendant encoder

57 Pendant pulse width modulator

58 Pendant radio frequency transmitter

59 Base diode 4

60 Pendant antenna

61 Base fuse

62 Base radio frequency receiver

63 Base perceptible output

65 Base diode 5

66 Base push button

67 Base diode 6

68 Base Central Processing Unit (CPU)

69 Base diode 7

70 Base speech circuit

71 Base diode 8

72 Base dialer

73 Base transistor 1

74 Base electronic telephone interface

75 Base resistor 7

76 Base hands free voice switched speakerphone

77 Base diode 9

78 Base battery

79 Base antenna

80 Base microphone

81 Base transistor 2

82 Base speaker

83 Base resistor 46

84 Pendant identification code jumpers for low frequency encoder

85 Base resistor 51

86 Pendant resistor 12

87 Base capacitor 3

88 Pendant resistor 13

89 Base transistor 7

90 Pendant capacitor 2

91 Base identification code jumpers for low frequency decoder

92 Pendant resistor 1

93 Sawtooth wave form generator

94 Pendent resistor 2

95 Comparator

96 Pendant resistor 3

97 Base transistor 3

98 Pendant resistor 5

99 Base transistor 6

100 Pendant resistor 4

101 Pendant diode 1 to pendant diode 2 connection

102 Pendant resistor 6

103 Pendant resistor 7

104 Pendant capacitor 1

105 Pendant diode 1

106 Pendant diode 2

107 Pendant resistor 8

108 Pendant transistor 1

109 Pendant resistor 10

110 Pendant transistor 2

111 Pendant resistor 11

112 Pendant capacitor 3

113 Pendant resistor 9

114 Pendant resistor 9z

115 Pendant diode 3

116 Pendant resistor 14

117 Pendant diode 4

118 Pendant diode 5

119 Pendant diode 6

120 Pendant capacitor 3

121 Pendant capacitor 4

122 Base battery switch connection

123 Speakerphone controller connection

124 Base resistor 49

125 Base resistor 48

126 Base battery

127 Phone line speech controller

128 Hang-up detector connection

129 Hang-up detector connection

130 Base embedded central processing unit (CPU)

131 Base transistor 4

132 Base transistor 5

133 Base resistor 8

134 Base resistor 9

135 Base resistor 10

136 Base resistor 11

137 Base capacitor 5

138 Base diode 10

139 Base resistor 4

140 Base resistor 5

141 Base resistor 6

142 Base resistor 50

143 Base capacitor 4

144 Base diode 2

145 Base diode 2a

146 Base resistor x1

147 Base capacitor x1

148 Base capacitor x2

149 Base DTMF generator

150 Base signal generator

151 Base speech controller connection

152 Base speech controller connection

153 Base decoder connection

154 Base decoder connection

155 Base resistor 1a

156 Base receiver

157 Base decoder

158 Base phone controller connection

159 Base phone controller connection

160 Base capacitor 3

162 Base resistor 3

163 Base signal generator

164 Base capacitor 1a

165 Base capacitor 1

166 Base capacitor 2

167 Base resistor 1

168 Base resistor 2

169 Base resistor 2a

170 Base resistor 45

171 Base speakerphone controller connection

172 Speakerphone controller

173 Base speakerphone controller connection

174 Base speakerphone controller connection

175 Base capacitor 34

176 Base capacitor 35

177 Base capacitor 6

178 Base capacitor 8

179 Base capacitor 7

180 Base capacitor 9

181 Base capacitor 10

182 Base capacitor 11

183 Base capacitor 12

184 Base capacitor 9a

185 Base resistor 12a

186 Base resistor 12

187 Base resistor 13

188 Base resistor 14

189 Base resistor 15

190 Base resistor 16

191 Base resistor 17

192 Base resistor 18

193 Base resistor 19

194 Base resistor 20

195 Base resistor 21

196 Base resistor 21a

197 Base resistor 22

198 Base resistor 24

199 Base resistor 25

Method Steps

202 Connect base to telephone system

204 Base has slow flashing visual indication

206 Press base call button 5 times

208 Base calls 1st 1-800 phone number

210 Base has fast flashing visual indication

212 Locate pendent at maximum distance from base

214 Press pendent call button 4 times

216 Base call 2nd 1-800 phone number

218 Adjust base antenna or relocate pendent

220 Deactivate and reactivate pendent for ready state

222 Check pendent battery expiration date and replace base battery if applicable

224 Pendent and base initialized and power on

226 Depress pendent button 3 times

228 Depress base button 3 times

230 1st momentary switch depression activates power circuit to latch on and pendant transmitter to send identity code

232 2nd and higher momentary switch depression allows base to verify pendant identity code

234 Identity code verified

236 No call made

238 Base disconnects any current calls and auto dials emergency number

240 One way voice to voice communication from emergency caller to emergency response operator using pendent or optional two way voice to voice communication using base

Elements

300 Base diode 12

301 Base diode 13

302 Base speakerphone connection

303 Base capacitor 13

304 Base capacitor 14

305 Base capacitor 15

306 Base capacitor 16

307 Base resistor 26

308 Base resistor 23

309 Base resistor 29

310 Base resistor 30

311 Base resistor 27

312 Base resistor 28

313 Base resistor 32

314 Base resistor 33

315 Base resistor 36

316 Base resistor 40

317 Base resistor 34

318 Base resistor 35

319 Base resistor 39

320 Base resistor 50

321 Base capacitor 21

322 Base capacitor 22

323 Base capacitor 20

324 Base capacitor 23

325 Base capacitor 24

326 Base capacitor 25

327 Base capacitor 26

328 Base capacitor 27

329 Base capacitor 28

330 Base capacitor 31

331 Base capacitor 33

332 Base capacitor 32

333 Base capacitor 30

334 Base capacitor 29

335 Base capacitor 18

336 Base capacitor 17

337 Base diode 14a

338 Base resistor 31

339 Base resistor x3

340 Base resistor x2

341 Base diode 11

342 Base decoder

### DETAILED DESCRIPTION

The present invention is an improved emergency communications system for communicating between an emergency caller and an emergency response operator. The system comprises two basic parts, the first part is a portable self-contained wireless remote personal pendant and the second part is a base unit.

The portable self-contained wireless remote control pendant includes a radio frequency transmitter for transmitting the valid signal to the base unit and a low frequency encoder that is connected to the transmitter being operative to generate a valid signal for the pendant. The pendant also includes circuitry to distribute operational commands to the transmitter and the encoder and includes a self-contained electrical power supply that is in electrical communication with the pendent circuitry. The pendent has a momentary switch that is connected to the pendent circuitry that is activated by the emergency caller to energize the pendent circuitry, a microphone is also coupled with the pendant circuitry and is operative to send voice communications from the emergency caller through the pendant transmitter to the receiver in the base to eventually be audibly received by the emergency response operator.

The base unit includes a radio frequency receiver for receiving a signal, having a low frequency decoder that is connected to the radio frequency receiver and that is operative to determine the validity of the receiver signal. The base unit also includes circuitry with a central processing unit that receives a communication from the low frequency decoder when a valid receiver signal is present. When a valid receiver signal is present the central processing unit has stored in memory at least one emergency telephone number and is operative to generate a control signal upon receipt of the valid receiver signal. This control signal is sent to a dial tone generator that is operative in response to the control signal from the central processing unit to generate a sequence of tones corresponding to the stored emergency telephone number in the central processing unit. In addition, the base unit circuitry has the capability of processing the voice signal transmitted from the pendant and subsequently transmitting the voice signal to the emergency response operator. A telephone interface circuit is operative to connect to the dial tone generator to the telephone line for the purpose of completing the emergency communication from the emergency caller to the emergency response operator.

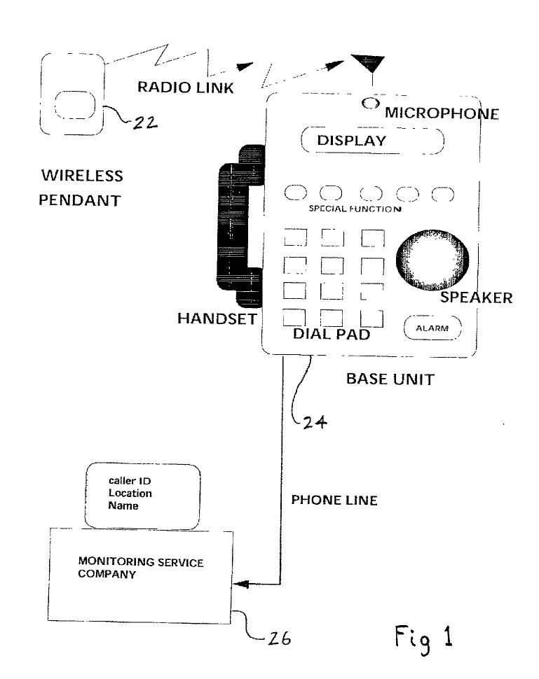

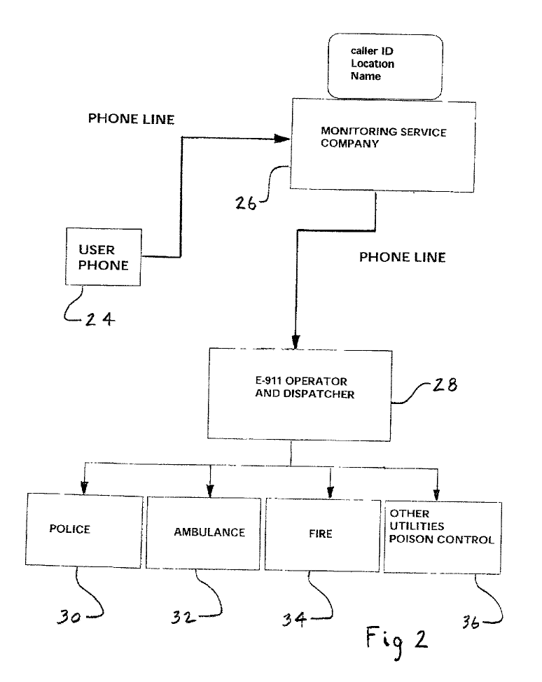

With initial reference to FIGS. 1 and 2, a block diagram in shown of the local or household, typical prior art emergency communications system. Shown is the prior art wireless pendant 22, the prior art base unit 24, and the connection to the third-party monitoring service 26 company who in turn contacts the 911 emergency response call operator 28 and the typical authorities contacted by the 911 emergency call operator 28. The typical authorities being police 30, ambulance 32, fire 34, and all other utilities such as poison control 36. It can be seen that all emergency communications must be communicated through the third party by service company 26, or in other words the third-party monitoring service company 26 is between the emergency caller who is using either the prior art wireless pendant 22 or the prior art base unit 24 to make the emergency call to the 911 operator 28. The initial purpose of the third-party monitoring service company 26 was two fold, first to provide verification of a true emergency by a callback to the emergency caller and once the emergency and the caller's identification were verified, the third-party monitoring service company 26 would contact the 911 emergency response operator 28 with the “true” emergency. Secondly, the third-party monitoring service is a method of generating ongoing revenue for the third-party monitoring service company 26. The system has not been without its problems, however, as there have been difficulties in the callback verification to the emergency caller causing critical time delays in the dispatching of emergency personnel to the location of the emergency caller.

There are normally two critical issues in an emergency situation, the first one this time, being the time for communication from the emergency caller to contacting the emergency response operator is critical, as this time, of necessity must absolutely be minimized. The second critical issue occurs in a situation with injured party maybe unaccompanied or unattended and is in a situation where they are incapacitated from either an injury, poisoning, or the like, and are not able to respond to the third-party monitoring service 26 verification call. With the advent of enhanced 911 emergency call services, wherein the emergency response operator 28 can determine identity and location of the emergency caller, the need for the third-party monitoring service 26 is obsolete, especially since there is the opportunity for the third-party monitoring service 26 to add communication lag time, and add another communication layer that increases the possibility for misinformation to be communicated between the emergency caller and the emergency response operator 28.

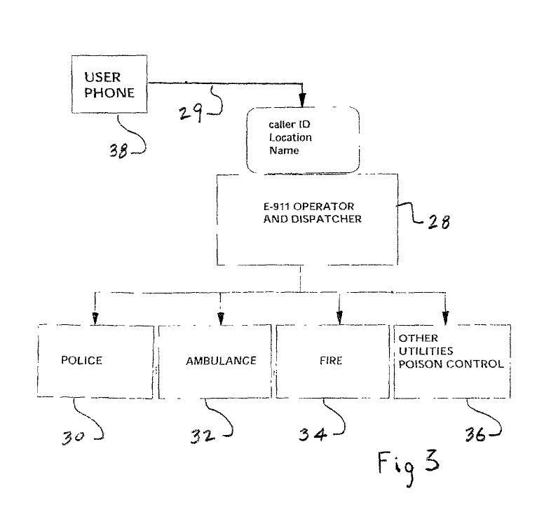

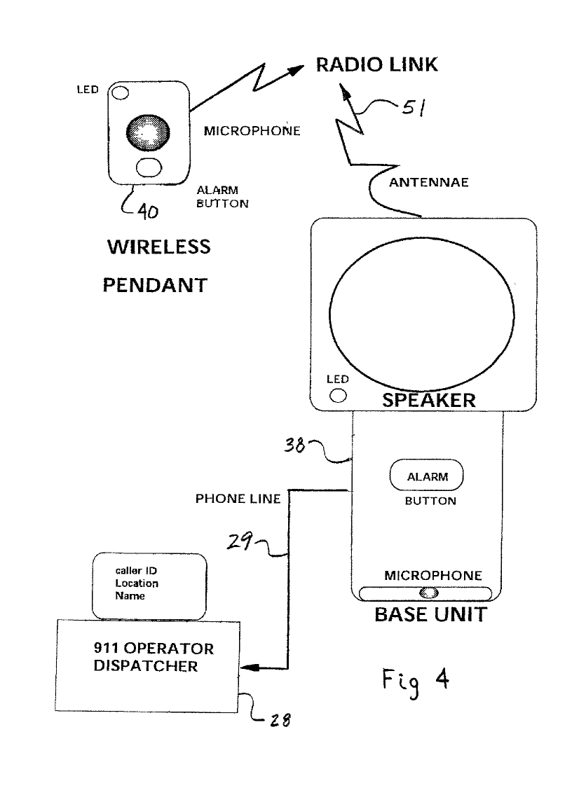

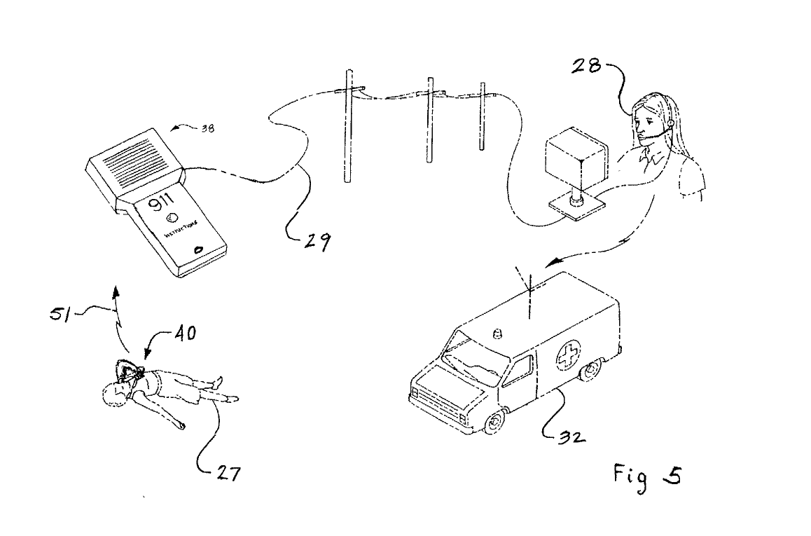

Looking to FIGS. 3, 4, and 5, block diagrams show an embodiment of the present invention for the emergency communication system, showing the emergency caller 27, the wireless pendant 40 being in wireless communication utilizing a valid radio frequency signal 51 with the base unit 38, and the telephone line 29 connection to the 911 emergency response call operator 28 with the typical authorities contacted by the 911 emergency call response operator 28. The typical authorities being police 30, ambulance 32, fire 34, and all other utilities such as poison control 36. It can be seen that the emergency caller 27 using either the wireless pendant 40 or the base unit 38 can make an emergency call directly to the 911 emergency response operator 28, who will know the caller identification and caller location, with the emergency response operator 28 immediately dispatching the emergency to the proper authorities. This results in a much more simple, direct, and faster system that the identified prior art as shown in FIGS. 1 and 2 with the third-party monitoring service, and is in accordance with two goals of emergency communications being the minimization of time and efficient communications between the emergency caller 27 who may be incapacitated and the 911 emergency response operator 28. The wireless pendant 40 not only has push button or momentary switch to initiate the emergency communication, but can also facilitate verbal communication from the emergency caller 27 to the 911 emergency response operator 28. As the pendant 40 is always on the person of the emergency caller 27, if the emergency caller 27 shall become quickly incapacitated, from possibly a stroke or heart attack, they would immediately be able to activate the pendant 40 to directly contact the 911 emergency response operator 28, who could immediately dispatch the ambulance 32, thus facilitating the simplest and fastest emergency communication possible. Alternatively, the emergency caller 27 could make the call from the base unit 38 being normally on a desk in the same manner as using pendant 40.

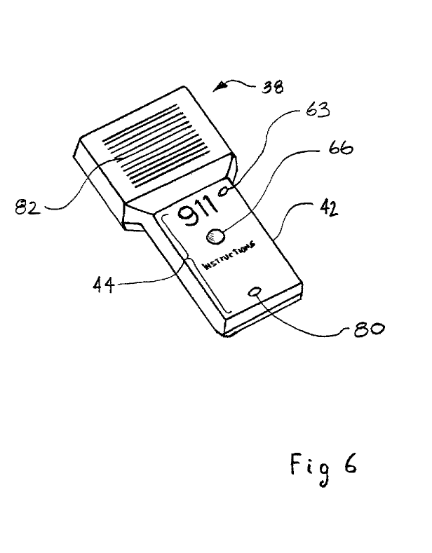

Turning now to FIG. 6 a perspective view is shown of an embodiment of the base unit 38 in its housing 42 that is normally situated on a desktop (not shown). Instructional indicia 44 details operating instructions for the base unit emergency caller. The housing 42 is preferably a parallelopiped shape, but could be any other number of alternative shapes, such as any combination of length, width, and height that would be in accordance with advances in circuitry and power supply or as future uses dictate. Housing 42 materials are preferably lightweight and moldable, such as plastics and the like. A base unit 38 optional momentary push button 66 when pushed activates the base unit 38 to make the emergency call without voice communication to the 911 emergency response operator, however, the 911 operator will know where the emergency call originated from and can dispatch an ambulance to the known location. This scenario is useful where the emergency caller may be incapacitated to such a degree that they are unable to speak. Alternatively, a speaker 82 and microphone 80 can be used with the base unit 38 to allow the base unit to function as a “hands free” speaker phone enabling the emergency caller to have two-way voice communication with the 911 operator to describe a more detailed nature of the emergency to the 911 emergency response operator.

Also, the base 38 can have a base perceptible output 63 to indicate that the base 38 is in an operational state when the base momentary push button 66 is depressed. The base perceptible output 63 can be in the form of a LED display, or an audible indication, or both.

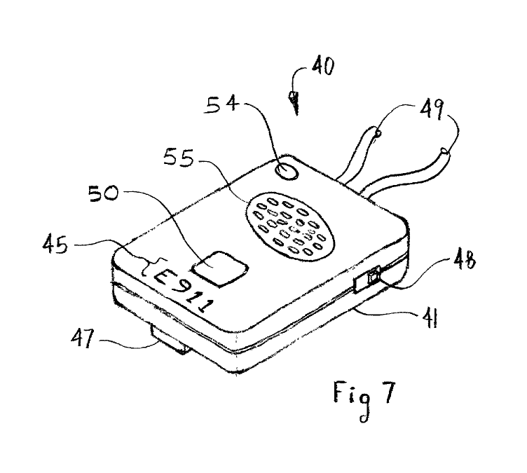

Looking to FIG. 7 a perspective view is shown of an embodiment of the portable self contained wireless remote personal pendent 40 in its housing 41 that is normally always in the possession of the emergency caller. The housing 41 is preferably a parallelopiped shape, but could be any other number of alternative shapes, such as any combination of length, width, and height that would be in accordance with advances in circuitry and power supply or as future uses dictate. Housing 41 materials are preferably lightweight and moldable, such as plastics and the like. The pendent 40 is a very small device that will typically fit easily in the palm of hand of the emergency caller, being similar in size to an automotive remote keyless entry radio frequency transmitter device, the pendent 40 weighs about 1 oz and is approximately 2 in. by 1.5 in. by 0.5 in. in dimensions. The emergency caller can keep the pendant 40 on their person by means of a waist belt clip 47, or an attachment loop 49 that can be configured as a necklace, a bracelet, a key chain, or a pocket chain. Instructional indicia 45 details operating instructions for the pendant 40. A pendant momentary push button 50 when pushed by the emergency caller activates the pendant 40 to send a valid radio frequency signal to the base unit, wherein the base unit processes the valid radio frequency signal to make the emergency call with the pendent 40 having the capability of one way voice communication from the emergency caller through the pendant microphone 55 to the to the 911 emergency response operator, enabling the emergency caller to describe a more detailed nature of the emergency to the 911 emergency response operator. However, as with the base unit, the 911 operator will know where the emergency call originated from and can dispatch an ambulance to the known location if the emergency caller may be incapacitated to such a degree that they are unable to speak with the use of the enhanced 911 emergency response system.

The pendent 40 alternatively can have a pendent slide switch 48 that activates the pendent into an operational state that allows the pendent momentary push button 50 to become functional, or the pendent slide switch 48 can be deactivated to extend pendent 40 power supply or battery life when the pendent 40 is not needed. Also the pendant slide switch 48 allows the pendant 40 to be reset if the momentary push button 50 is inadvertently or accidentally pushed, thus allowing the emergency call to be aborted. Otherwise, without the switch 48 the pendant power supply 46 would have to be removed from the pendant 40 to accomplish a pendant 40 reset. Without the slide switch 48, the pendent 40 is always in the operational state that allows the pendent momentary push button 50 to become functional. Also, the pendent 40 can have a perceptible output 54 to indicate that the pendent 40 is in an operational state when the pendent momentary push button 50 is depressed. This perceptible output 54 can be in the form of a LED display, or an audible indication, or both.

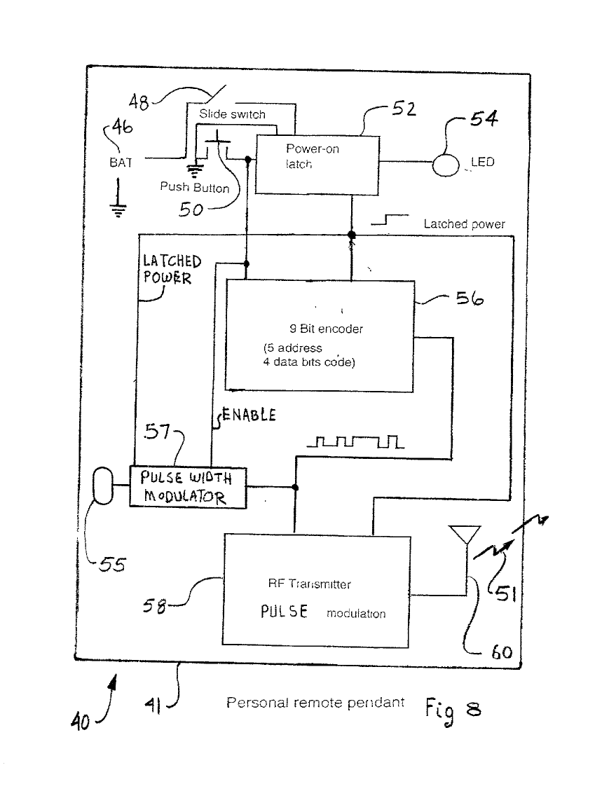

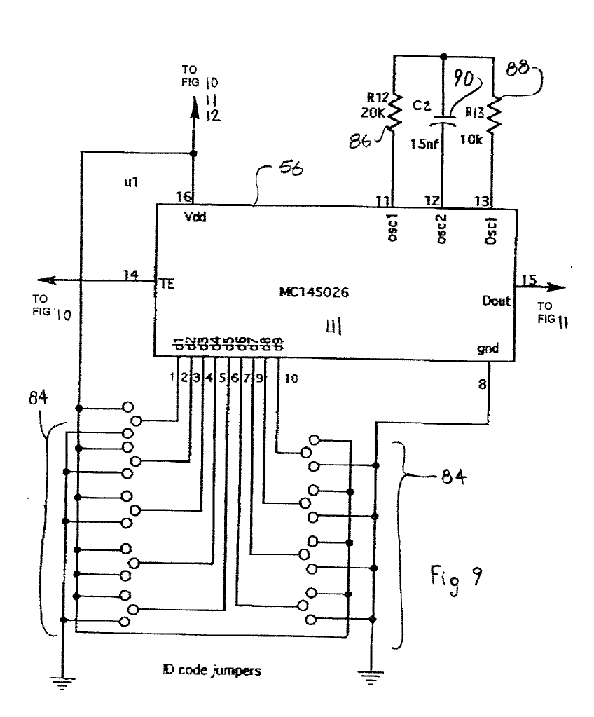

Turning to FIGS. 8, 9,10, 11, and 12 the principal summary features and detailed schematic interrelationships and circuitry components of the portable self-contained wireless remote personal pendant 40 are shown of an embodiment. Accordingly, the pendant housing 41 contains the various electrical components of the pendant 40 as shown in FIG. 8. FIGS. 9,10, 11, and 12 show the schematic circuit detail of the pendant 40.

Starting with FIG. 8 , through the pendant electrical power supply 46, power is supplied through the pendent momentary switch 50 and the pendant slide switch 48 that are connected in parallel to the pendant circuitry 52. After the emergency caller manually moves slide switch 48 to a closed or “on” state the pendent circuitry 52 is activated. The pendant circuitry 52 activation can be optionally indicated by a perceptible output 54. The perceptible output 54 can take the form of a visual indication by use of a LED, or an audible indication by use of a sound generating device, or to enhance the indication of pendent circuitry 52 activation, use of both a visual indication and an audible indication can be used for the perceptible output 54 and be incorporated into the pendent 40. Note that slide switch 48 could be optional in pendent 40, wherein the slide switch 48 would be replaced with a closed electrical connection, thereby allowing an unchanged function of momentary switch 50. Optionally, without the use of the slide switch 48 a “time out” feature could be used with additional circuitry to automatically switch pendant circuitry 52 on and off to reduce power consumption from the power supply 46. This “time out” circuitry would remove the need for the emergency caller to manually open and close switch 48 for the reset and initialization functions of the pendant 40. The purpose of a slider switch 48 is to de-energize the pendent circuitry 52 when the pendent 40 is not in use thus extending the life of the pendent electrical power supply 46. Pendant circuitry 52 functions as a power on latching switch for supplying power to the encoder 56 and the transmitter 58, wherein the power on latching function is disabled or placed in an inactive state by opening or turning “off” slide switch 48.

To prepare the pendant 40 for use the slide switch 48 is manually placed in a closed or “on” state by the emergency caller, which readies the pendant circuitry 52 to activate the power on latch for the encoder 56 and the transmitter 58 when the monetary switch 50 is pushed during an emergency situation. When the momentary switch 50 is manually activated or pushed by the emergency caller the power on latch is activated of the pendent circuitry 52 with latched power on to the pendent transmitter 58 and to the pendant encoder 56. Simultaneously, a momentary pulsed power signal is also sent to the encoder 56 wherein the encoder 56 sends a serial pulse train to the pendant transmitter 58 that sends a valid radio frequency signal 51 through the pendant antenna 60 to the base unit. Wherein the base unit automatically calls the emergency response operator . At this time the encoder 56 is deactivated while the pendant microphone 55 and transmitter 58 both remain activated allowing one way voice communication between the emergency caller operating through the radio frequency signal 51 to the base unit and eventually resulting in audible reception by the emergency response operator as long as slide switch 48 remains in a closed state. Optionally, microphone 55 can utilize a pulse width modulator 57 that acts to output a consistent radio frequency transmission strength for the pendant 40 regardless of the emergency callers voice volume level that the microphone 55 receives. When slide switch 48 is manually placed in an open state the latched power is deactivated to the transmitter 58 and microphone 55.

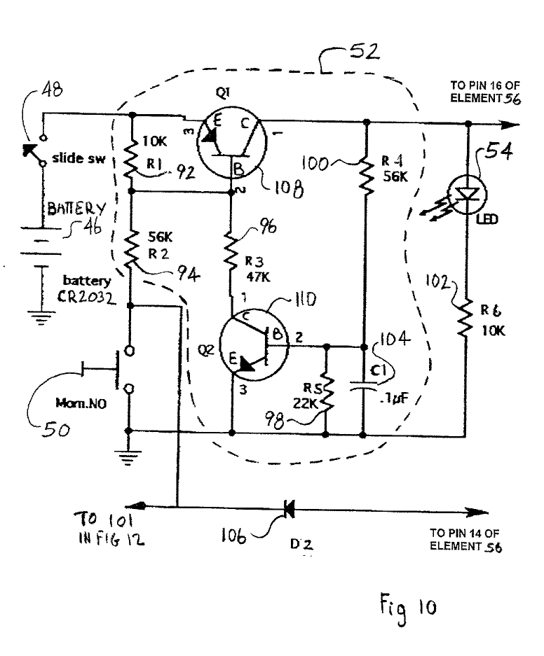

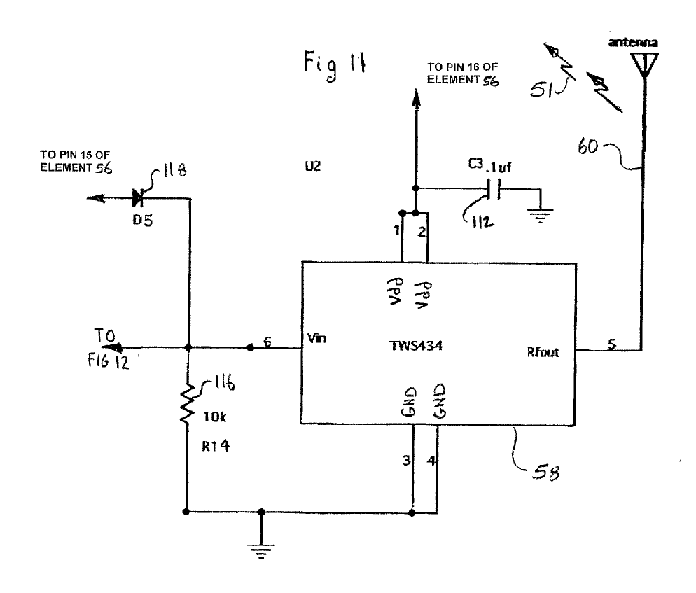

Turning to FIGS. 9, 10, 11, and 12 shown are detailed circuit schematic diagrams with a description following for the pendent 40. Starting with pendent electrical power supply 46, which is two lithium type batteries connected in series that are each a Panasonic lithium battery model number CR 2032, or any acceptable equivalent that meets the maximum power needs being about 6.2 to 6.4 volts and 8 milli-amps plus the space requirements of the pendant 40. The pendent power supply 46 is connected to electrical ground and to the pendent slide switch 48. The slide switch 48 is a standard single pole single throw (SPST) type of switch having the requirements of being able to fit within the following constraints of the pending housing 41 and meeting the electrical power requirements of the pendant circuitry 52 which are about 6.2 to 6.4 volts and 8 milli-amps. Upon manual sliding of the slider switch 48 which places the slide switch 48 in a closed state by the emergency caller the pendant circuitry 52 is in a ready state for the power latch function to be activated by the momentary switch 50 which is pushed or depressed by the emergency caller and at the time of the emergency. When the pendent circuitry 52 is in the ready state, wherein slider switch 48 is closed and momentary switch 50 is not depressed the power requirements of the circuitry 52 are minimal at less than 1 micro-amp to maximize the life of the pendent power supply 46. The momentary switch 50 is normally open and when depressed and acts to momentarily close the circuit between the pendant circuitry 52 and electrical ground. The momentary switch 50 is preferably a Digikey part number EG 1870-ND or an equivalent that will meet the requirements of pendent housing 41 available volume and meeting the electrical power requirements of the pendant circuitry 52 which are about 6.2 to 6.4 volts and 8 milli-amps. The pendant circuitry 52 that functions as a power on latch for the encoder 56 and the transmitter 58, includes a two resistors in series being respectively resistor 92 and resister 94 that are in-between the pendant power supply 46 and acting through the momentary switch 50 to electrical ground. Resistor 92 and resister 94 to act as part of a voltage divider circuit connected to transistor 108, which is preferably a Digikey part number FMMT3906R-ND or an acceptable equivalent. When the momentary switch 50 is depressed, the pendent circuitry 52 is energized by the base connection or pin 2 of transistor 108 being connected to electrical ground through resistor 94. This base current in turn causes the transistor 108 collector or pin 1 power level to rise to the power supply 46 voltage which is at the emitter or pin 3 of transistor 108. An optional perceptible output 54 which is shown to be in the form of a visual indicating LED or alternatively, in the form of an audible perceptible output is connected to the collector of transistor 108 and to electrical ground through resistor 102. The perceptible output 54 functions to give an indication of circuitry 52 being latched on in power to the emergency caller with the perceptible output receiving D.C. power of about 6.2 to 6.4 volts through resistor 102. The perceptible output 54 is shown in the embodiment of being a visual indicating LED or an equivalent. Another transistor 110, which is preferably a Digikey part number FMMT3904R-ND or an acceptable equivalent, has voltage applied to its base or pin 2 through resistor 100 originating from the collector of transistor 108. The base voltage of transistor 110 is further divided by the use of resistor 98 being in parallel with the capacitor 104 that is in between the base of a transistor 110 and electrical ground. Transistor 110 is biased causing its collector at pin 1 to drop its voltage level causing current to flow through resistor 96 which in turn causes transistor 108 to remain in the on state independent of whether the momentary switch 50 is depressed or not. At this point circuitry 52 is now latched in the on state and can only be deactivated by a manually opening the slider switch 48 to remove the power supply 46 from the circuitry 52.

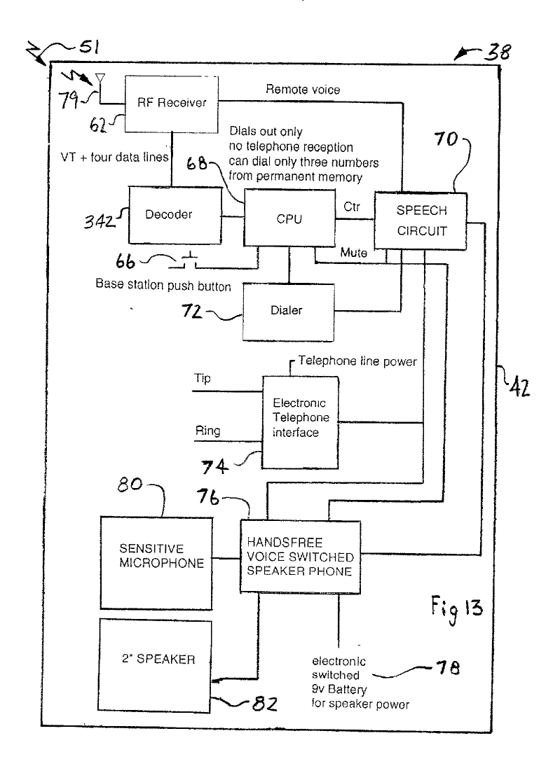

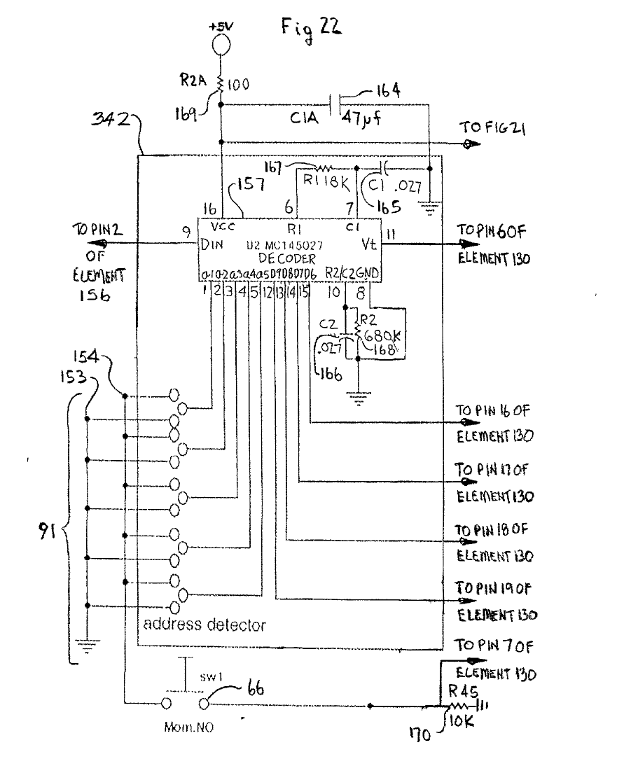

The voltage appearing at the collector of transistor 108 is applied to the encoder 56 at pin 16. The encoder 56 is preferably a Motorola part number 145026 DR2 or a Holtek part number HT6026-16DIP/NSOP or an equivalent. The latching function of the circuitry 52 is to minimize power consumption of the pendant 40 for maximum power supply 46 life. The encoder 56 has the capability for encoding up to 512 different signaling codes, 5 code bits are used for defining 32 different blocks of 16 address words. The general function of encoder 56 is to generate unique address codes to be recognized by the matching address decoder 342 shown in FIGS. 13 and 22 in the base unit 38. The address code is constructed of two parts, the first 5 bits of the 9 bits are the fixed address block, the second 4 bits are the learned bits at the base unit 38 using the receiver 62, decoder 342, and CPU 68 as shown in FIGS. 13, 20, 21, and 22. The encoder 56 digital addressing code sequence is determined by the jumper pad connections 84 that are preset during manufacturing and are identified by bar code stickers placed on the pendant housing 41 during manufacturing. The encoder 56 is connected to resistor 86 at encoder 56 pin 11, capacitor 90 at encoder 56 pin 12, and resister 88 at encoder 56 pin 13, wherein resistor 86, capacitor 90, and resister 88 are connected together respectively as shown, and function to be frequency determining components for the internal R.C. oscillator. The momentary switch 50 connects the encoder 56 at pin 14 to electrical ground through diode 106. This signal causes a serial pulse train to be sent by the encoder 56 at pin 15 through diode 118 to the transmitter 58 at pin 6 each time the momentary switch 50 is depressed. Although a 9 bit encoder 56 is used, a 13, 15, or 19 bit encoder could be used depending upon the need for additional addresses. The transmitter 58 is preferably a Liapac Technologies Part number TWS434 or equivalent. The transmitter 58 remains activated to send radio frequency signals through the antenna 60 connected to the transmitter 58 at pin 5. The antenna 60 is preferably a standard wire type. The transmitter 58 remains activated by the voltage supplied by transistor 108 through resistor 100. Pins 1 and 2 of the transmitter 58 are connected to electrical ground through capacitor 112 that functions to be a decoupling capacitor supplying transient current to the transmitter 58 oscillator. This transmitter oscillator only turns on when the input voltage is approximately a positive 0.3 volts and is fully on when the voltage is above 0.6 volts.

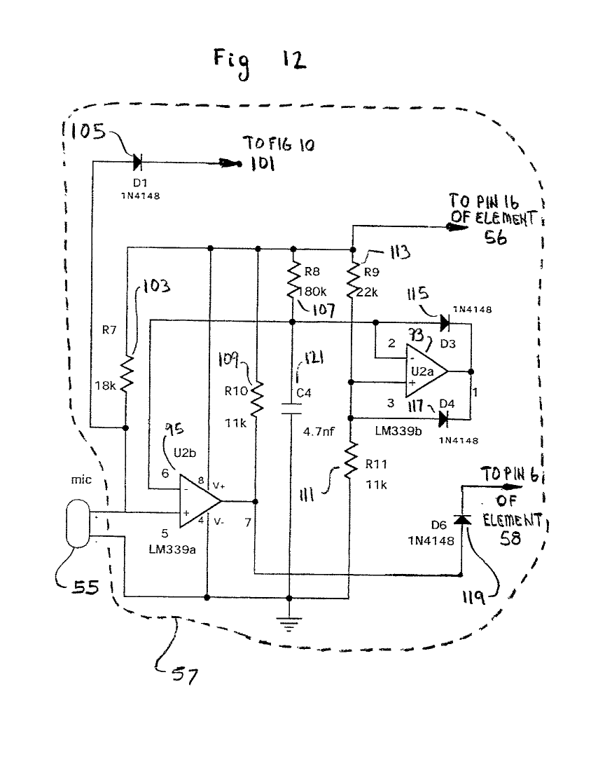

As shown in FIG. 12, use of the microphone 55 with the pulse width modulator circuitry 57 for providing consistent radio frequency 51 transmission strength with varying volume voice input from the emergency caller to the microphone 55 is subsequently described. The microphone 55 is connected to the comparator 95 on one lead to pin 5 of the comparator 95 which is also connected to resistor 103 and diode 105. On the microphone 55 the other lead is connected to pin 4 of the comparator 95 that is also connected to ground. The comparator 95 acts in conjunction with a sawtooth waveform generator 93 with that uses diodes 115 and 117. The comparator 95 and waveform generator 93 are a combined component that is preferably a National model number LM339 a/b or an acceptable equivalent. As the sawtooth waveform is generated and connected to pin 6 of the comparator 95, when this saw tooth waveform exceeds the voice signal level from the microphone 55 present at pin 5 of the comparator 95, the output at pin 7 of the comparator 95 switches from a high level to a low level acting through diode 119 to the transmitter 58. Each cycle of the saw tooth wave causes the output at pin 7 of the comparator 95 to switch at a different time depending on the microphone 55 voltage level. The sawtooth frequency is about 10,000 cycles per second. The input electrical power to the pulse width modulator circuitry 57 is shut off whenever momentary switch 50 is depressed by conducting current through diode 105 to ground. This in turn causes the output at pin 7 of the comparator 95 to go to a low-level allowing the signal from the encoder 56 to be sent to the transmitter 58. The remainder of the components in the pulse with modulator circuitry 57, including resistor 109, resister 107, resistor 1113, resistor 111, and capacitor 121 act to set the required voltages and condition the electrical power for the microphone 55, the generator 93, and the comparator 95.

Optionally, other modulation schemes such as amplitude modulation could be used being described as follows. Although not shown in the figures, voice communication signals from the emergency caller without the use of the pulse width modulator circuitry 57 as shown in FIG. 12 can be detected by the pendent microphone 55 that is directly connected to the transmitter 58 at pins 3, 4, for one microphone 55 lead and to pin 6 of the transmitter 58 for the other microphone 55 lead. The microphone 55 with or without the use of the pulse width modulator circuitry 57 is a Panasonic Wm-61A or a Digikey part number P9925-ND or an acceptable equivalent. The microphone 55 is biased by resistor 114 that is located between pin 6 and pins 1 and 2 of the transmitter 58. The bias level for the transmitter 58 is set by resistor 116 that is located between pin 6 and pins 3 and 4 of the transmitter 58. The transmitter 58 will continue to transmit voice communication signals from the emergency caller until the slide switch 48 is manually opened.

Looking to FIG. 13, the principal features and interrelationships of the general circuitry components of an embodiment for the base unit 38 are shown. Accordingly, the housing 42 contains the various electrical components of the base unit 38 as shown. The housing 42 is preferably a parallelopiped shape, but could be any other number of alternative shapes, such as any combination of length, width, and height that would be in accordance with advances in circuitry and power supply or as future uses dictate. Housing 42 materials are preferably lightweight and moldable, such as plastics and the like. Starting with the valid radio frequency signal 51 which is received by the base unit antenna 79, from the pendant 40, which is then communicated to the receiver module 62 receiving both the valid radio frequency address encoded signals and the voice encoded signals, both of which comprise the valid radio frequency signal 51 received from the pendant 40. However, the voice signal does not go to the decoder 342 but instead is separately routed to a speech circuit 70 in preparation for transmission to the emergency response operator. The radio frequency receiver module 62 is in electrical communication with the decoder 342, wherein the decoder 342 decodes the address bits received by the radio frequency receiver 62 to determine if a valid low frequency transmission address has been received. The decoder 342 signals the central processing unit 68 if the decoder 342 has determined that a valid low frequency address has been received. The decoder 342 address codes to match the pendant radio frequency signal transmission are selected in the manufacturing phase through the use of jumpers for the solder bridges in the decoder 342.

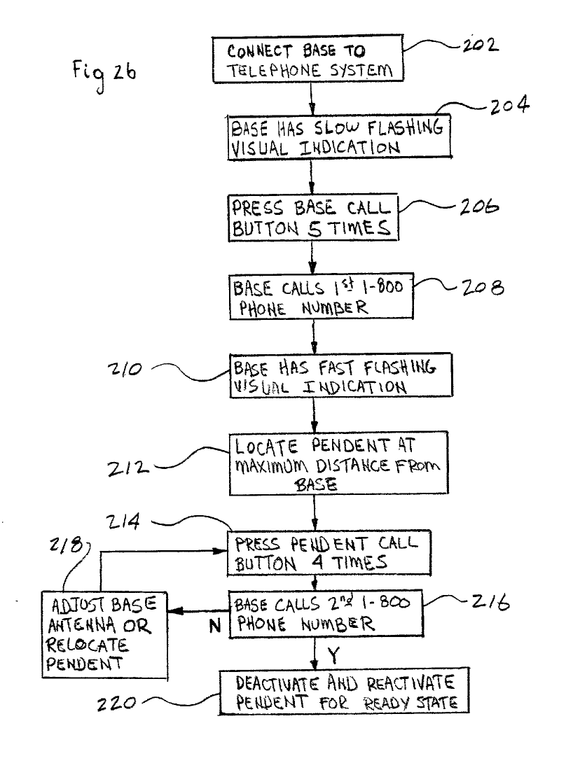

The central processing unit 68 and associated circuitry control all operations of the base unit 38. Once the central processing unit 68 receives a communication from the decoder 342, when the decoder 342 determines that a valid radio frequency address signal is present, the central processing unit 68 then checks the data bits of the valid low frequency signal for the presence of repeatable identification data. At this point the central processing unit 68 stores these data bits in memory during the initialization of the system comprising the pendant 40 and the base unit 38. These particular data bits are unique to the pendant and the base unit will only respond to these signals in the future. This determination of a valid address code will prevent confusion and cross talk between multiple pendants associated with multiple base units 38 that are in close proximity to each other, for instance in an apartment building. This unique feature of the central processing unit 68 being able to learn the unique identity of the pendant low frequency address signal during the first use greatly simplifies the manufacturing process wherein the pendant 40 and the base 38 do not have to be pre matched individually for identical encoding and decoding of the radio frequency signal that is transmitted from pendent 40 to the base 38. This learning process of the central processing unit 68 is detailed in the description given for FIG. 26.

An optional base momentary switch 66 can be used to initiate the emergency call from the base unit 38 in addition to the ability to initiate an emergency call from the pendent 40. When the emergency caller depresses momentary switch 66 the central processing unit 68 is operative to generate a control signal. The base unit 38 includes a dial tone generator 72 that is controlled by the central processing unit 68. The dial tone generator 72 is operative in response to the control signal from the central processing unit 68 and is used to generate a sequence of tones corresponding to a stored emergency telephone number in the central processing unit 68. The central processing unit 68 generates the control signal either upon receipt of the valid low frequency address code from the decoder 342 when the emergency call is made from the pendent 40 or optionally when the emergency caller depresses the momentary switch 66 on the base unit 38. The dial tone generator 72 is connected to the electronic telephone interface circuit 74 that is operative to connect to the dial tone generator 72 to a telephone line for the purpose of completing the emergency call or communication.

Another option for the base unit 38 is to add the capability for a “hands free” speakerphone allowing for two-way voice communication between the emergency caller who is using the base unit 38 and the emergency response operator. This is accomplished by adding a microphone 80 and a speaker 82 to the base unit 38 along with hands free voice switching and speakerphone support circuitry 76 and a base unit power supply 78 to operate all of the aforementioned elements required to make the base unit 38 operable as a “hands free” speakerphone.

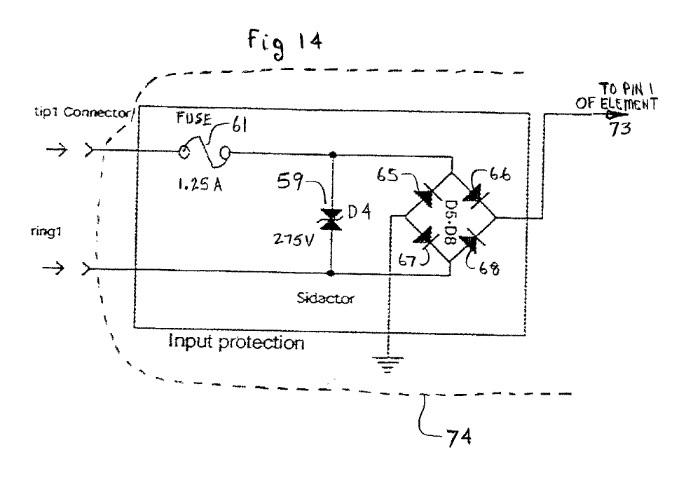

Turning to FIGS. 14, 15, 16, 17, 18, 19, 20, 21, 22, 23, 24, and 25 shown are detailed circuit schematic diagrams with a description following for the base unit 38. Starting with FIG. 14 which shows the the electronic telephone interface circuitry 74 which is between the existing phone lines 29 and the base unit assembly 38. The electronic telephone interface circuitry 74 includes the telephone signals, TIP 1 and RING 1 that are first passed through a 1.25 amp fuse 61 to comply with Federal Communications Commission (FCC) Part 68 Current requirements during the case of a power line short circuit. The fuse 61 is preferably a 2AG Bussman or little fuse pigtail or an acceptable equivalent rated at 1.25 amps. Additional over voltage protection is provided by diode 59 which is located between TIP 1 and RING 1 and provides a direct short circuit in the event the input voltage exceeds levels specified by the telephone companies. Diode 59 is preferably a 275 volt rated P3100 EB Sidactor available as a TO-92 Teccor from Digikey or an equivalent. A diode rectifier bridge which includes diodes 65, 66, 67, and 68 protects against polarity reversal on the phone lines and provides power to the base unit circuitry from TIP 1 and RING 1 to pin 1 of transistor 73. Diodes 65, 66, 67, and 68 are 1N4937 type or alternatively 1N4004-7 each being rated to at least 400 volts or any suitable equivalent.

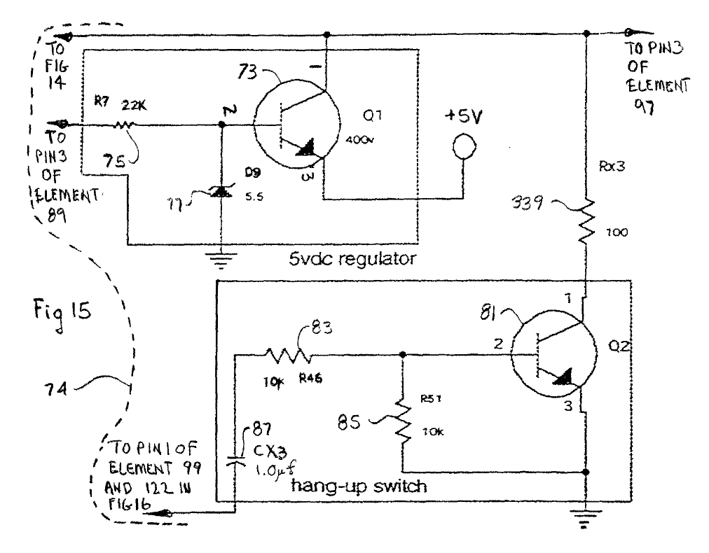

Next, looking to FIG. 15, that includes the 5 volt D.C. regulator and the hang up switch which also forms a part of the of electronic telephone interface circuitry 74. Transistor 73 provides regulated voltage to the base unit circuitry with reference to the ground through a zenor diode 77. Transistor 73 is preferably a NPN ECG 399 with at least a 400 volt reverse breakdown or a suitable equivalent. Transistor 81 provides signaling to other devices on the telephone line during “off hook” conditions to cause these other devices to disconnect thus allowing the emergency call to capture the telephone line for the purposes of allowing the emergency call to be completed. Transistor 81 is also preferably a NPN ECG 399 with at least a 400 volt reverse breakdown or a suitable equivalent. Appropriate voltage and electrical power conditioning is provided by resistors 75, 339, 83, 85 and capacitor 87. Resister 75 is connected between pin 2 of transistor 73 and pin 3 of transistor 89, with resister 339 being connected between pin 1 of transistor 73 to pin 1 a transistor 81. Resistor 83 and capacitor 87 are connected in series from pin 2 of transistor 81 to pin 1 of transistor 99 and resistor 125. Resistor 85 is connected between pin 2 of transistor 81 and pin 3 of transistor 81 that is also connected to ground.

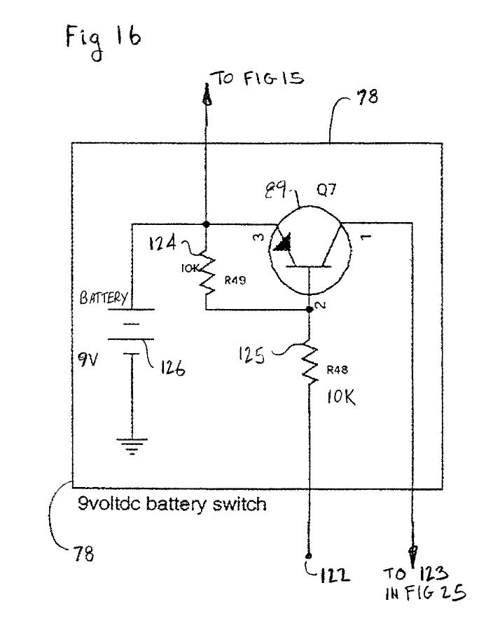

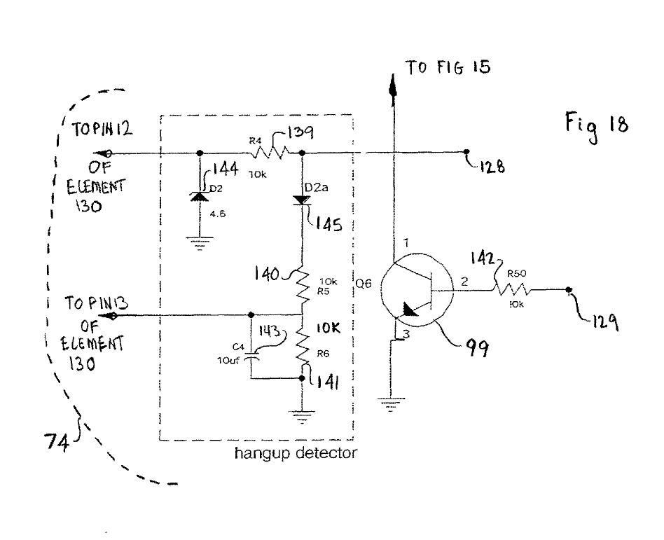

Further to FIG. 16 an auxiliary self-contained power supply 78 within the base unit is shown that provides power to the base unit speaker circuitry and receiver. This base auxiliary power supply includes a standard 9 volt battery 126 which is utilized in providing power to the base speaker drive circuitry 76 and the base receiver 62. Transistor 89 in conjunction with resistor 124 and resistor 125 act to control the 9 volt battery 126 output to the speaker 82 and to transistor 99 in conjunction with resister 142 as shown in FIG. 18. The 9 volt battery 126 is normally in a standby state wherein the base circuitry consumes about 1.0 milli-amps mostly from the receiver. The 9 volt battery 126 engages in an active state when it is used primarily for powering the speaker 82 when the emergency communication is made. Once an emergency communication has been made the 9 volt battery 126 should be replaced. Resistor 124 is connected between pin 2 in transistor 89 and pin 3 of transistor 89 a nd resistor 125 is connected between pin 2 of transistor 89 and pin 1 of transistor 99. Transistor 89 is preferably a PNP ECG A893 or suitable equivalent.

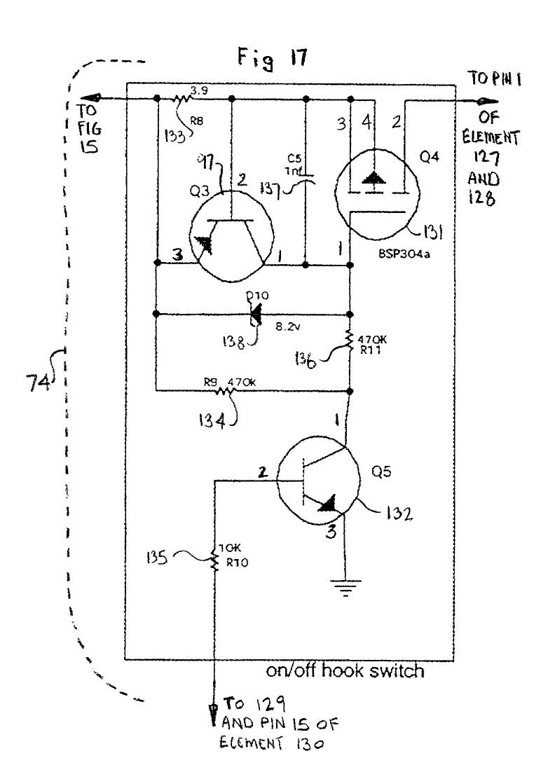

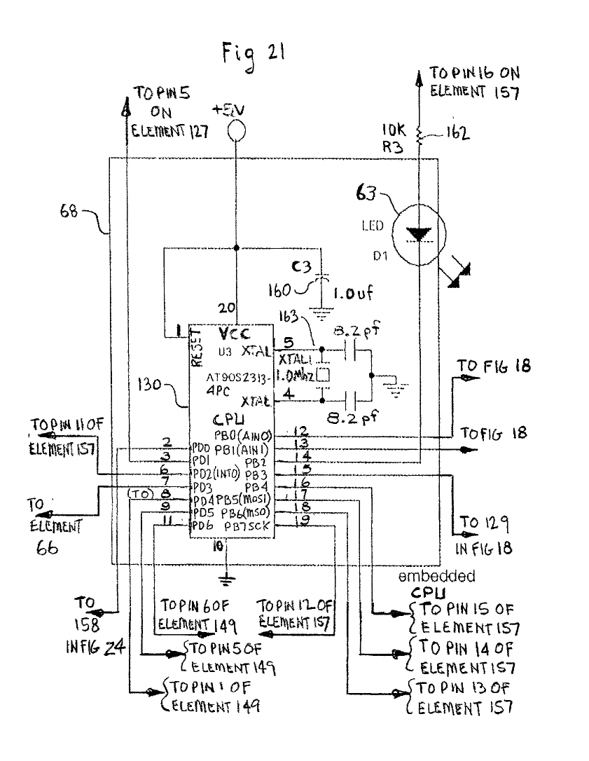

Next looking to FIG. 17, off hook switch and on hook switch circuitry is shown which also forms a part of the electronic telephone interface 74. The off hook switch and on hook switch circuitry includes transistors 97, 131, and 132 in conjunction with resistors 133, 134, 135, and 136, capacitor 137 and diode 138 control the on hook and off hook switch in conjunction with the CPU 130 as shown in FIG. 21. Resistor 133 is connected between pins two and three of transistor 97 with capacitor 137 connected between pins 1 and 2 of transistor 97, and diode 138 is connected between pin 1 and pin 3 of transistor 97. Resistor 136 is connected between pin 1 of transistor 131 and pin 1 of transistor 132 with resister 134 connected between pin 1 of transistor 132 and pin 3 and a transistor 97. Pin 3 of transistor 97 is subsequently connected to pin 1 of transistor 73 and resistor 339 which eventually connects to pin 1 of transistor 81. Pin 2 of transistor 131 interconnects to pin 1 of the phone line speech controller 127 and also to the hang up detector connection 128. Transistor 132 at pin 2 connects through resistor 135 to pin 15 of the CPU 130 and to connection 129 which connects through resistor 142 to pin 2 of transistor 99. Transistor 97 is preferably a PNP ECG A893 or suitable equivalent, with transistor 131 being preferably a BSP 304a type with a P channel enhancement mode of 300 volts or suitable equivalent, and transistor 132 being preferably a NPN M 12 or suitable equivalent.

Further to FIG. 18 which is also a part of the electronic telephone interface 74 circuitry, a hang up detector is shown. The hang-up detector includes resistors 139, 140, and 141, diodes 144 and 145, and capacitor 143 that operate in conjunction with the CPU 130 as shown in FIG. 21. Capacitor 143 and resistor 141 are connected in parallel with one end to ground and the other end to pin 13 of the CPU 130. Pin 13 of the CPU 130 is also connected to resistor 140, diode 145, and resistor 139 which are all connected in series to pin 12 of CPU 130. Pin 12 of CPU 130 is also connected to ground through diode 144. FIG. 18 also shows transistor 99 that controls the base power supply battery 126 to the speaker circuitry 76. Transistor 99 is connected to ground at pin 3, is connected to resistor 142 at pin 2, and is connected at pin 1 to resistor 125 in the battery 126 power supply circuitry 78, and to capacitor 87 in the hang-up switch circuitry 74 in FIG. 15. Transistor 99 is preferably a NPN M 12 or suitable equivalent.

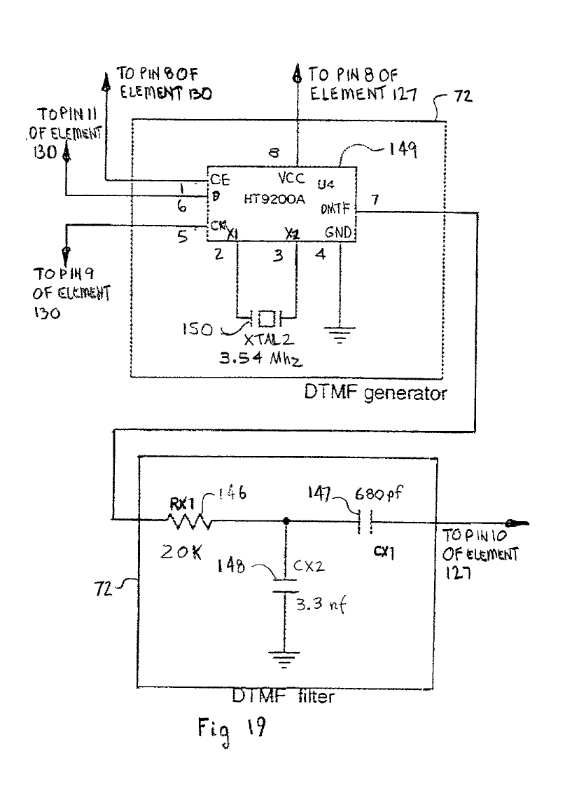

Next looking to FIG. 19 the DTMF generator and the DTMF filter circuitry is shown which forms the dialer circuitry 72. DTMF generator 149 is the dial tone generator that is controlled by the CPU 130, with the generator 149 being connected to the CPU 130 at pins 1, 5, and 6 as shown in FIG. 19. The CPU 130 stores at least three numbers in memory which are used to initialize the system on its first use and to provide automatic dialing for connecting to the 911 emergency response operator. The DTMF generator 149 at pin 8 connects to pin 8 of the phone line speech controller 127 to complete the power supply. The DTMF generator 149 also utilizes signal generator 150 at pins 2 and 3, and connects to ground at pin 4. The signal generator 150 is preferably a Murata Digikey part number ECS ZTA-3.58 MG or an equivalent. The DTMF generator 149 generates the dial tone signals at pin 7 and connects to the DTMF filter with resistor 146 and capacitor 147 in series with capacitor 148 to ground in-between resistor 146 and capacitor 147 with capacitor 147 connected to pin 10 of the phone line speech controller 127 for the purpose of interfacing the dial tones to the telephone circuit 29. The DTMF generator 149 is preferably a Holtek model number HT 9200A or suitable equivalent.

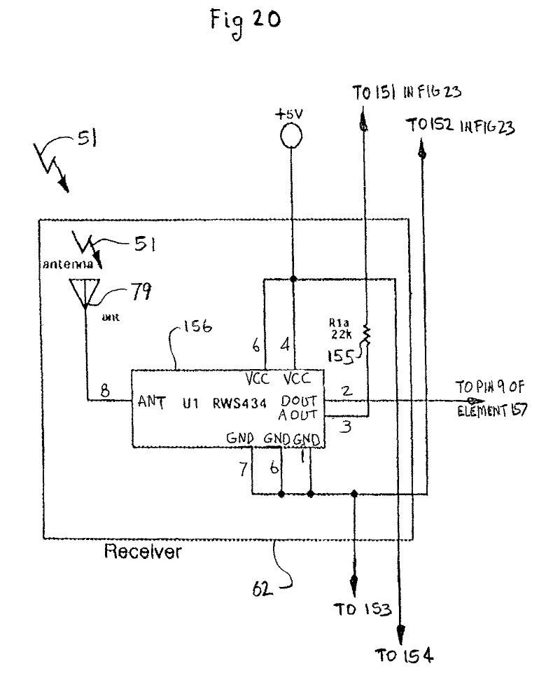

FIG. 20 shows the radio frequency receiver circuitry 62 which detects the coded signals from the pendant 40 and that transmits both the emergency call signal and the voice signal. The call signal and the voice signal are depicted as signal 51 that is received by antenna 79 that is connected to pin 8 of the receiver 156. The receiver 156 receives power at pins 4 and 6 and is connected to ground at pins 1, 6, and 7. The receiver 156 output is at pins 2 and 3, with pin 2 connected to pin 9 of the decoder 157 and pin 3 connecting through resistor 155 to the speech controller 127. The receiver 156 is preferably a Liapac Technologies Part number RWS434 or equivalent.

Next turning to FIG. 21 the CPU circuitry 68 is shown which controls all operations of the base unit assembly 38. The CPU 130 is preferably an ATMEL AT 90S 2313-4PC chip an acceptable equivalent. More specifically, the CPU 130 receives power at pin 1 and pin 20 with a ground coupling at capacitor 160, with the CPU 130 having a direct ground at pin 10. Pin 6 the CPU 130 receives a signal from the decoder 157 that indicates a valid address has been received from the radio frequency signal 51. Pins 16, 17, 18, and 19 of the CPU 130 receive the data bit signals from the decoder 157 wherein the CPU 130 checks for the presence of repeatable identification data unique to the radio frequency 51 transmission from the pendant 40. The CPU 130 then stores the these data bits in memory during the initialization of the pendant 40 and base 38 system. These bits are unique to the personal pendant 40 that is worn by the emergency caller and the base unit 38 will respond only to these signals in the future. This avoids false alarms when multiple pendant 40 and base unit 38 sets are in use that are in close proximity to each other such as the case in an apartment building. The benefit of this initialization process is that in the manufacturing process the pendant 40 and the base unit 38 do not have to be individually matched for data bit parity between the encoder 56 of the pendant 40 and the decoder 156 of the base unit 38. In other words, the base unit 38 CPU 130 learns the identity of the pendant 40 specific encoded data bits during the first use in the transmission of radio frequency signal 51 from the pendant 40 to the base unit 38.

The CPU 130 interface with the speaker phone controller 172 and the phone line controller 127 originates from pins 2 and 3 of the CPU 130, with pin 2 connecting to pin 24 of the controller 172 through resistor 312 and pin 3 of CPU 130 connecting to pin 5 of controller 127. Pin 7 of the CPU 130 connects to momentary switch 66 that is normally open and receives 5 volts of D.C. power when the momentary switch 66 is depressed thus closing the circuit between the 5 volt D.C. power supply and pin 7 of the CPU 130 to place an emergency call from the base unit 38. The momentary switch 66 is preferably a Digikey part number EG 1870-ND or an equivalent that will meet the requirements of base housing 42 available volume and meeting the electrical power requirements of the base 38 circuitry which are a approximately 9 volts and 8 milli-amps. The CPU 130 interface with the DTMF generator 149 is at CPU 130 pins 8, 9, and 11 connecting respectively to pins 1, 5, and 6 of the DTMF generator 149 for the purpose of converting CPU 130 signals to place the emergency call into the appropriate dial tones to interface with telephone lines 29. The CPU 130 control of the hang up detector and the on hook switch and off hook switch is at pins 12, 13, and 15. More particularly , the hang up detector utilizes signals from pins 12 and 13 from the CPU 130 that has a continuation signal to the phone line speech controller 127 for detection of emergency call activation. Specifically, the CPU 130 signal at pin 15 to the on hook switch and off hook switch connects to pin 2 of transistor 132 through resistor 135, and acts to disable any current calls that are in use on the phone line 29 to allow emergency call to be placed or made. Pins 4 and 5 of the CPU 130 utilize signal generator assembly 163 the includes a signal generator connected to pins 4 and 5, with each of pins 4 and 5 coupled to ground through capacitors as shown in FIG. 21. The signal generator assembly 163 is preferably a Murata Digikey part number ECS ZTB1000J or an acceptable equivalent.

An LED 63 is used as a perceptible output for the base unit 38 to indicate that the system is activated, the LED 63 also has a varying output to indicate step-by-step progress in the initialization set up when the CPU 130 learns the identity of the pendant 40 during its first use as detailed in FIG. 26. The LED 63 receives 5 volts of D.C. power from pin 16 of the decoder 157 through resistor 162 and receives an activation signal from pin 14 of the CPU 130.

FIG. 22 shows the decoder circuitry 342 which decodes the address bits received by the receiver to determine if a valid transmission address has been received from the pendant 40 and signals this fact to the CPU 130 via level changes at the output of the decoder 157. More particularly, the decoder 157 receives a signal from the receiver 156 at pin 9 of the decoder 157 and signals this fact to the CPU 130 via level changes at the output Vt at pin 11 of the decoder 157. The decoder 157 also utilizes identification code jumpers 91 for low frequency decoder address code settings with the address codes to match the pendant 40 radio frequency signal 51 that is transmitted to the receiver 156. This is accomplished by having the address codes matched in groups at the factory through the use of jumpers 91 formed by solder bridges connected to pins 1, 2, 3, 4, and 5 of the decoder 157. The data bits output of the decoder 157 are at pins 12, 13, 14, and 15 that are connected to the CPU 130 for the purpose of determining the presence of repeatable identification data from the pendant 40 transmitted signal 51. The pendant 40 transmitted signal 51 verification process for determining the presence of repeatable identification data is given in more detail in the initialization process section of this description as detailed in FIG. 26. Decoder 157 power is received at pin 16 through resistor 169 and uses capacitor 164 to condition the power supply. Pins 6 and 7 of the decoder 157 are connected by resistor 167 with pin 7 connecting to ground through capacitor 165 to bias the circuitry. In addition, pin 10 of the decoder 157 connects to ground for a current drain through capacitor 166 and resistor 168 that are connected in parallel with pin 8 connected to ground. The decoder 157 is preferably a Motorola part number MC145027 or an equivalent.

Momentary switch 66 is the base unit 38 activation button which initiates the emergency call from the base unit 38. Momentary switch 66 is activated by depressing the button thus closing the circuit that is used for placing an emergency call and is connected between the address detector connection 154 and ground through resistor 170 with the non ground portion of momentary switch 66 identified as connection 154 being connected to the receiver 156 at pin 6. Depressing momentary switch 66 has the effect of connecting the power supply of the receiver 156 to ground through resistor 170 and deactivates the receiver 156. The other portion of the address code jumpers 91 identified as connection 153 is connected to ground.

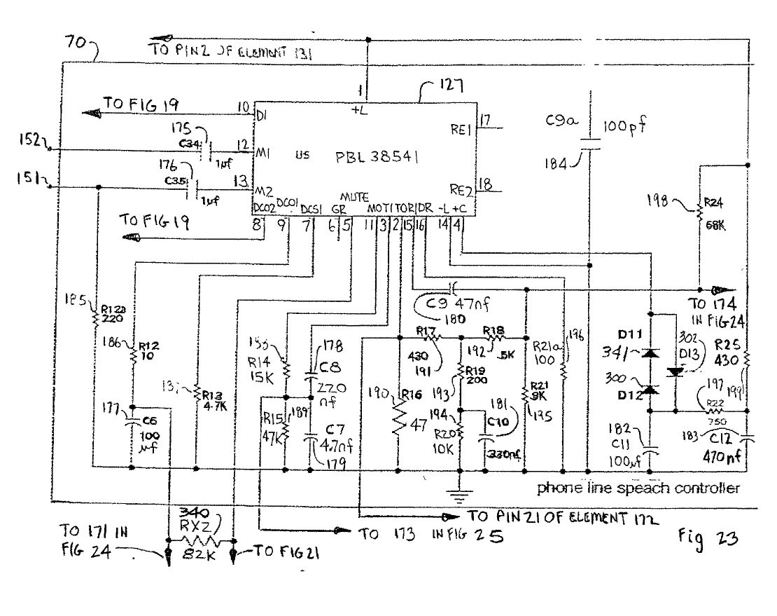

FIGS. 23, 24, and 25 are combined to define circuitry that provides the interface control of the telephone line for both receiving and transmitting to the public phone system lines and also control of the base unit microphone and loudspeaker to enable “hands free” operation of the base unit as a speaker phone for the emergency caller when the emergency communication is being made from the base unit. The circuitry in FIGS. 23, 24, and 25 consist of a a standard package from Ericsson that principally contains control circuit chips with Ericsson part numbers PBL 38541 identified is element 127 and PBL 38813 identified as element 172. This Ericsson package circuitry is defined as a voice switched speakerphone circuit with a loudspeaker amplifier in conjunction with a universal speech circuit. The PBL 38541 chip contains all the necessary circuitry for a monolithic integrated speech transmission circuit for use and electronic telephone interface applications and the PBL 38813 chip contains all the necessary circuitry, amplifiers, detectors, comparators, and control functions to accommodate a voice switched while speaking, “hands free” telephone.

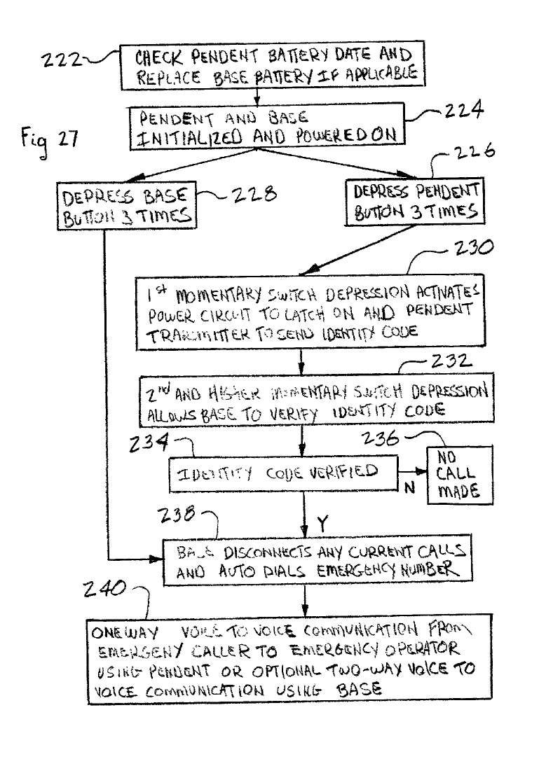

The speech circuit 70 as shown in FIG. 23 includes the phone line speech controller 127 which is preferably an Ericsson part number PBL 38541 or an equivalent and the associated circuitry also as depicted in FIG. 23. Due to the specific function of controller 127 the required associated circuitry is shown in the Ericsson PBL 38813 application notes in Ericsson FIG. 27 on page 13 of the January 1998 issue, with some modifications particular to the use in this application. All of the following pin number references are relation to controller 127, unless otherwise specified. Pin 1 receives the on and off the hook switch control signals from pin 2 of transistor 131 and the connection point 128 of the hang up detector. Pin 10 receives the signals from the DTMF generator 149 acting through the DTMF filter as shown in FIG. 19. Pins 12 and 13 coupled through capacitors 175 and 176 receive the remotely radio frequency transmitted pendant 40 voice communication signals, with these signals coming directly from the receiver 156 pin 3 acting through resistor 155. Pin 8 is a power supply for the DTMF generator 149.

Pins 9, 7, 5, 11, 3, 2, 15, 16, 14, and 4 are all connected to a grouping of circuitry components including resistors, capacitors, and diodes that create the required biases, couples and current flow directions as specified in the aforementioned Ericsson PBL 38813 application notes for the purpose of switching the speaker phone “hands free” option on and off and speaker phone controller 76. These specific components and the mounting in relationships are detailed in FIG. 23 with a summary following. Pin 13 is coupled to capacitor 176 in series with resister 185 to ground, pin 9 is connected to ground through resistor 186 and capacitor 177 in series with a connection between resistor 186 and capacitor 177 to resistor 340 and continuing on to connection 171. Pin 7 is connected to ground through resistor 187 and pin 5 is connected to resistor 340 and continues on to pin 3 of the CPU 130. Pin 11 connects to ground through resistors 188 and 189 in series with pin 3 connected to ground through capacitors 188 and 189 in series, with an intermediate connection 173 in-between both sets of resistors 188 and 189 and capacitors 188 and 189. Pin 2 is connected to ground through resistor 190 and also directly connects to pin 21 of the speaker phone circuit chip 172. Pin 2 is also connected to ground through resistors 191, 193, and 194 connected in series with capacitor 181 connected in parallel to ground with resistor 194. In addition, in-between resistors 191 and 193, resistor 192 and resistor 195 connect to ground in series. Capacitor 180 couples between pin 15 and between resistors 192 and 195 that also forms connection point 174 that is connected to pin 1 through resistor 198. Connection point 174 also connects to ground through resistor 199 and capacitor 183 in series with another connection to ground through resistor 197 and the capacitor 182 connecting in between resistor 199 and capacitor 183. Pin 16 connects to ground through resistor 196 and pin 14 connects to ground and is coupled to pin 1 through capacitor 184. The intermediate point between resistor 197 and capacitor 182 connects to a diode bridge and includes diodes 300, 302, and 341 that terminates at pin 4.

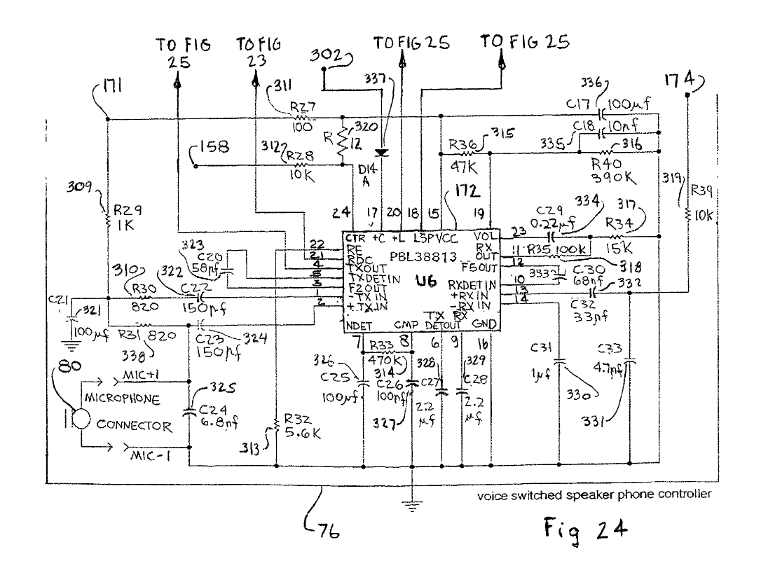

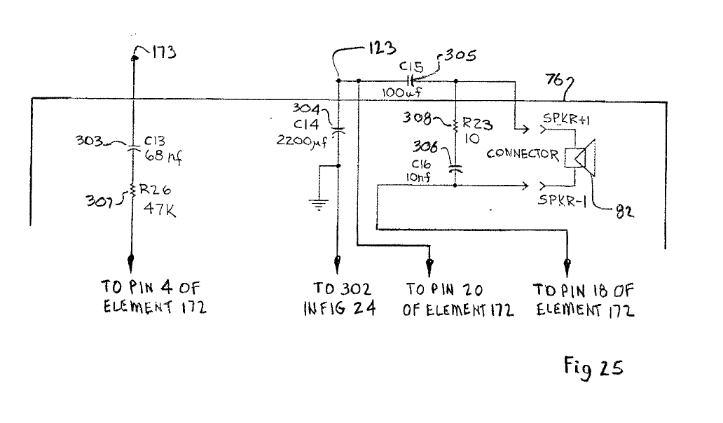

The speaker phone controller 76 is shown in FIGS. 24 and 25 and includes the speaker phone controller chip 172 and the associated circuitry. The speaker phone controller chip 172 is preferably an Ericsson part number PBL 38813 or an equivalent. Due to the specific function of controller 172 the required associated circuitry is shown in the Ericsson PBL 38813 application notes in Ericsson FIG. 27 on page 13 of the January 1998 issue, with some modifications particular to the use in this application. All of the following pin number references are relation to controller 172, unless otherwise specified. Microphone 80 uses capacitor 325 as a lead couple with one microphone lead to ground and the other microphone lead coupled through capacitor 324 to pin 2. The microphone 80 non grounded lead is also connected through resistors 338 and 309 in series to connection point 171 connecting to pin 9 of controller 127 through resistor 186, connection point 171 also connects to pin 24 through resistors 311 and 320 in series. In addition, pin 1 is connected through capacitor 322 and resister 310 in series to a point in-between resistor 338 and 309 continuing on through capacitor 321 to ground. Speaker 82 uses resistor 308 and capacitor 306 in series between leads with one lead going directly to pin 18 and the other lead connecting through capacitor 305 directly to pin 20 and connecting through capacitors 304, 305 and diode 337 all in series to pin 17. There is also an intermediate connection to ground between capacitor 304 and diode 337.

Pins 3, 5, 4, 21, 22, 7, 8, 6, 9, 16, 14, 13, 10, 12, 11, 33, 19, and 15 are all connected to a grouping of circuitry components including resistors, capacitors, and diodes that create the required biases, couples and current flow directions as specified in the aforementioned Ericsson PBL 38813 application notes for the purpose of switching the speaker phone “hands free” option on and off and operating with the speech circuit 70. These specific components and the mounting in relationships are detailed in FIGS. 24 and 25 with a summary following. Pins 3 and 5 are coupled by the capacitor 323, pin 4 connects to point 173 in FIG. 25 through resistor 307 and capacitor 303 that are connected in series. Pin 21 connects directly to pin 2 of controller 127, and pin 22 connects to ground through resistor 313. Pin 7 is coupled ground through capacitor 326 and pin 8 is coupled to ground through capacitor 327 with resistor 314 connected between pins 7 and 8. Pin 6 is coupled to a ground through capacitor 328 and pin 9 is coupled to ground through capacitor 329 with pin 16 directly connected to ground. Pin 14 is coupled to ground through capacitor 330 and pin 13 is coupled to ground through capacitors 332 and 331 connected in series, in addition from a point in-between capacitors 332 and 331 connecting through resistor 319 and capacitor 180 in series to pin 15 of controller 127. Pins 10 and 12 are a coupled by capacitor 333 and pin 11 is connected to ground through resistors 318 and 317 in series, also, pins 11 and 23 are connected through resistor 318 and capacitor 334 in series. Pin 19 is connected to pin 15 through resistor 315 with pin 19 being connected to ground through resistor 316 and capacitor 335 in parallel, in addition, pin 19 is connected to pin 15 through resistor 316 and capacitor 335 in parallel connected to capacitor 336 in series.

TABLE 1

| | Element Number ₋ Value in Ohms |
|---|---|
| Resistors | (unless otherwise specified) |
| 75 | 22K |
| 79 | 100 |
| 83 | 10K |
| 86 | 20K |
| 88 | 10K |
| 92 | 10K |
| 94 | 56K |
| 96 | 47K |
| 98 | 22K |
| 100 | 56K |
| 102 | 10K |
| 103 | 18K |
| 107 | 180K |
| 109 | 11K |
| 111 | 11K |
| 113 | 22K |
| 114 | 10K |
| 116 | 10K |
| 124 | 10K |
| 125 | 10K |
| 133 | 3.9 |
| 134 | 470K |
| 135 | 10K |
| 136 | 470K |
| 139 | 10K |
| 140 | 10K |
| 141 | 10K |
| 142 | 10K |
| 146 | 20K |
| 155 | 22K |
| 162 | 10K |
| 167 | 18K |
| 168 | 680K |
| 169 | 100 |
| 170 | 10K |
| 185 | 220 |
| 186 | 10 |
| 187 | 4.7K |
| 188 | 15K |
| 189 | 47K |
| 190 | 47 |
| 191 | 430 |
| 192 | 5K |
| 193 | 200 |
| 194 | 10K |
| 195 | 9K |
| 196 | 100 |
| 197 | 750 |
| 198 | 68K |
| 199 | 430 |
| 307 | 47K |
| 308 | 10 |
| 309 | 1K |
| 310 | 821 |
| 311 | 100 |
| 312 | 10K |
| 313 | 5.6K |
| 314 | 470K |
| 315 | 47K |
| 316 | 390K |
| 317 | 15K |
| 318 | 100K |
| 319 | 10K |
| 320 | 12 |
| 331 | 821 |
| 340 | 82K |

TABLE 2
Capacitors
Element Number_{————}Value in micro-farads (unless otherwise specified)
87 1
90 15 nano farads
104 0.1
112 0.1
121 4.7 nano farads
137 1 nano farad
143 10
147 680 pico farads
148 3.3 nano farads
164 47
165 0.027
166 0.027
175 1
176 1
177100
178 220 nano farads
179 4.7 nano farads
180 47 nano farads
181 330 nano farads
182 100
183 470 nano farads
184 100 pico farads
303 68 nano farads
304 2200
305 100
306 10 nano farads
321100
322 150 nano farads
323 58 nano farads
324 150 nano farads
325 6.8 nano farads
326 100
327 100 nano farads
328 2.2
329 2.2
330 1
331 4.7 nano farads
332 33 nano farads
333 68 nano farads
334 0.22
335 10 nano farads
336 100

TABLE 3

Diodes
Element Number_{————}Standard diode number
62 P3100EB
65 1N4937
66 1N4937
67 1N4937
68 1N4937
77 1N5232
105 1N4148
106 1N4148
115 1N4148
117 1N4148
118 1N4148
119 1N4148
138 1N476
144 Zenor 4.6
145 1N4148
300 1N4148
301 1 N4148
3411 N4148

Method of Using the Exemplary Embodiment

Method of Initialization for Use of the Pendent and Base Unit

Referring to FIG. 26 a flow chart is shown illustrating diagrammatically the initialization process for the pendent 40 and base 38. As the pendant 40 and the base 38 must be matched for a valid address signal to prevent interference or cross talk in the situation where there are multiple pendants 40 and base units 38 in use being in close proximity such as in an apartment building, an initialization process must be performed prior to the emergency caller using the pendant 40 to being able to send an emergency communication to the emergency response operator through the base unit 38. To lessen the manufacturing burden of having to factory match during the manufacturing process the address identity codes of the matching pendant 40 and base 38 encoder 56 and decoder 157 respectively, which account for total of 512 different signaling codes, the central processing unit 130 of the base 38 has the capability of learning the pendant's 40 unique low frequency address identity code during the initialization process. This lessens the requirement of having to correlate the low frequency address signal codes between the pendent 40 and base 38 in groups of 16 rather than matching all 512 individual different radio frequency signaling code combinations between pendant 40 and base 38 during manufacturing.

To initialize the emergency communications system, which includes matching the address identity codes between the pendant 40 and the base 38 a special sequence must be followed. The first step 202 is to connect the base 38 to the existing telephone system 29, when this step is complete the user should note a slow flashing visual indication 204 which is preferably in the form of a red LED 63, the slow flashing a visual indication indicates that the base unit is now ready for the initialization process to begin. However, the base unit 38 may not have the visual indication and would thus require that step 206 be completed after step 202. Moving to the next step 206 the momentary switch 66 or a push button on the base should be pressed to five times in sequence consecutively which in turn causes the base 38 to call a base 1-800 phone number 208. This phone number will answer and confirm the base operation, in addition if the base has the optional speakerphone capability the answering of this base 1-800 phone number can be used to provide information to the person or caller who is initializing the system. At this time the base will recognize the line disconnect from the base 1-800 phone number corresponding to a fast flashing visual indication 63 on the base 210. If the base does not have the momentary switch 66 or push button step 208 and step 210 can be eliminated and step 212 can be commenced. At this time the pendent 40 should be located at a distance away from the base 38 that is presumed to be the maximum operating distance from the base 38 step 212 during an emergency call, when pendent 40 is at its maximum operating distance from the base 38, which should be approximately no more than 60 ft., then the pendent 40 momentary switch 50 or push button should be pressed 4 times consecutively 214. At this point when the four identity codes from pendent 40 are detected by the base 38, the base 38 will call a pendant 1-800 telephone number to confirm operation of the pendant 40 step 216. If the base 38 cannot initiate the calling of this pendant 1-800 telephone number the base antenna 79 should be repositioned vertically or horizontally or the pendant 40 should be moved closer to the base 38 until the base 38 can call the pendant 1-800 telephone number 218, by again depressing the pendant call button 50 four times consecutively 214. Once the base successfully calls the pendant 1-800 telephone number 216, the pendant power must be deactivated and subsequently reactivated to place the pendant in a ready state to make an emergency communication 220 by the emergency caller. This deactivation and reactivation of the pendant is preferably done by use of a slide switch 48 in the pendant housing 41, but also may be done by removing and reinstalling the pendant power supply 46.

Method of Using the Pendent and Base Unit to Make an Emergency Communication

Referring to FIG. 27 is a flow chart is shown illustrating diagrammatically the process for making an emergency communication utilizing the pendant 40 or base 38. To start, and before the occurrence of an emergency situation the pendent power supply 46 or battery date that is given on the pendant housing 41 should be checked for not being expired, and in the base 38, the base power supply 78 or battery should be replaced if it is used with the optional speakerphone if either the power supply or base batteries have expired date wise or an emergency call has been previously placed using this same power supply 78 or base battery 222. The next step is to confirm that the pendant 40 and base 38 have completed the initialization process for matching the pendants 40 radio frequency signal code transmission 51 to the base unit 38 and that the pendent 40 is powered on with the optional slide switch 48 closed and the installation of an unexpired power supply 46 or battery, step 224.

In the case of an emergency situation the emergency caller should depress the pendent button 50, 3 times, step 226, the 3 button depressions minimize the occurrence of a false alarm or accidental emergency call being made. The first pendent push button depression activates the pendant 40 power circuit to latch on and subsequently causes the pendant transmitter 58 to send an identity code to the base 38, step 230. Subsequent pendant 40 button 50 pushes, being the second button push and higher allow the base to verify the identity code of pendent 40, step 232. When the base unit 38 verifies the identification code of the pendent 40, step 234 the base 38 then checks the telephone line 29 for any current calls or any off hook phone(s) and immediately disconnects those current calls and automatically dials the stored emergency number 238. If the identity code verification 234 from the pendent 40 does not verify, the base unit 38 does not place the emergency call 236. Returning to step 238 once the base 38 places the emergency call, one-way voice to voice communication from the emergency caller 27 through microphone 55 in the pendent 40 to the emergency response operator 28 is effectuated 240. Even if the emergency caller 27 is incapacitated to the point where they are unable to speak, the emergency call is still placed by the pendant 40 and base unit 38, and utilizing the enhanced 911 emergency response system wherein the emergency response operator 28 will know the identity and location of the emergency caller 27. If the emergency caller 27 is able to speak, they can further describe the nature of the emergency in more detail to the emergency response operator 28. Optionally, the emergency caller 27 can initiate the emergency call from the base unit 38, similar to the pendant 40, the base unit button 66 should be depressed three times by the emergency caller 27, step 228. Making the emergency call from the base 38 eliminates steps 230, 232, 234, and 236, and results in the base 38 immediately disconnecting the current calls on the telephone line 29 and automatically dialing the stored emergency number 238. The base 38 will place the emergency call similar to the pendant signal 51 causing the base 38 to place the emergency call, and that the base unit 38 even without the optional speakerphone will still allow the emergency response operator 28 to know the identification and location of the emergency caller 27 with enhanced 911 emergency services. Optionally, if the base unit 38 has the speakerphone option, two-way voice to voice communication will be possible from the emergency caller 27 to the emergency response operator 28 and from the emergency response operator 28 back to the emergency caller 27, step 240.

Conclusion

Accordingly, an embodiment of present invention of an emergency communication system has been specifically described that makes a reduction in the time to communicate an emergency, enhances the accuracy of the emergency communication, and improves access of the emergency caller to the emergency response operator. However, alternatively the pendant housing could be in the shape of a name tag of the type that would clip or pin on a person's shirt similar to that used in retail sales for the salesclerk's name. The pendant being contained in the name tag would have voice activation circuitry for making the emergency call. The retail clerk would speak specific keywords that would automatically activate pendant circuitry into making the emergency call and engaging the pendant in one-way voice communication from the retail clerk to the emergency response operator. This will allow emergency response operator to hear the substance of the conversation between a retail clerk and the person engaging in criminal activity, such as robbery and also with the use of enhanced 911 emergency response services the location of the retail clerk. To not alert the person engaged in criminal activity that the emergency call was being made, the emergency response operator would not be able to engage in voice communication to the retail clerk and the retail clerks specific keywords that are spoken to activate the pendant circuitry into making emergency call would be words that do not arouse suspicion from the person engaging in criminal activity.

It should be appreciated, though, that the present invention is defined by the following claims and their legal equivalents construed in light of the prior art so that modifications or changes may be made to the exemplary embodiments of the present invention without departing from the inventive concepts contained herein.

1. An emergency communication system for communicating between an emergency caller and an emergency response operator, comprising:
(a) a base unit comprising:
(i) a radio frequency receiver for receiving a signal;
(ii) a low frequency decoder connected to said receiver operative to determine validity of said receiver signal;
(iii) base unit circuitry including a central processing unit that receives a communication from said decoder when a valid receiver signal is present, said central processing unit stores the valid receiver signal in memory for future use, said central processing unit has stored in memory at least one emergency telephone number and is operative to generate a control signal upon receipt of the valid receiver signal;
(iv) a dial tone generator that is operative in response to the control signal from said central processing unit to generate a sequence of tones corresponding to the stored emergency telephone number;
(v) a telephone interface circuit that is operative to connect said dial tone generator to a telephone line for the purpose of completing an emergency communication; and
(b) a portable self contained wireless remote personal pendent comprising:
(i) a radio frequency transmitter for transmitting the valid signal to said base unit;
(ii) a low frequency encoder connected to said transmitter operative to generate the valid signal;
(iii) pendent circuitry to distribute operational commands to said transmitter and said encoder;
(iv) a self contained pendent electrical power supply in electrical communication with said pendent circuitry;
(iv) a pendent momentary switch connected to said pendent circuitry that is activated by the emergency caller to energize said pendent circuitry;
(v) a microphone coupled with said pendent circuitry is operative to send one way voice communications from the emergency caller through said transmitter to said receiver to be audibly received by the emergency response operator.

2. An emergency communication system according to claim 1 wherein said base unit circuitry further includes a base momentary switch that is activated by the emergency caller to generate the control signal to place said dial tone generator and said telephone interface circuit in the operative state for the purpose of completing the emergency communication to the emergency response operator.

3. An emergency communication system according to claim 2 wherein said base unit further includes circuitry to require said base momentary switch to be activated up to three consecutive times for said central processing unit to generate the control signal for initiating the emergency communication to prevent accidental or inadvertent initiation of the emergency communication by the emergency caller.

4. An emergency communication system according to claim 2 wherein said base unit circuitry further includes a speaker, a microphone, speakerphone circuitry, and a base electrical power supply to enable said base unit to operate as a hands free voice activated speakerphone to allow two way transmission of voice to voice communication between the emergency caller and the emergency response operator.

5. An emergency communication system according to claim 2 wherein said base unit circuitry further includes a means for producing a base perceptible output in response to an initialization state and activation.

6. An emergency communication system according to claim 4 wherein said base electrical power supply is a battery.

7. An emergency communication system according to claim 5 wherein said base perceptible output is a visual display.

8. An emergency communication system according to claim 5 wherein said base perceptible output is an audible display.

9. An emergency communication system according to claim 1 wherein said base unit further includes circuitry to generate override signals simultaneously with the control signal while completing the emergency communication such that the override signals cause any off hook phone on the telephone line to be disconnected, allowing the emergency communication to be completed.

10. An emergency communication system according to claim 1 wherein said base unit is contained within a common housing.

11. An emergency communication system according to claim 10 wherein said base unit housing is substantially parallelopiped in shape.

12. An emergency communication system according to claim 11 wherein said base unit housing further includes operating instruction indicia visibly disposed on said base unit housing.

13. An emergency communication system according to claim 1 wherein said base unit further includes circuitry to require said pendant momentary switch to be activated up to three consecutive times for said central processing unit to generate the control signal for initiating the emergency communication to prevent accidental or inadvertent initiation of the emergency communication by the emergency caller.

14. An emergency communication system according to claim 1 wherein said encoder has the capability for up to five hundred and twelve different signaling codes to reduce the opportunity for interference from identical signal codes when multiple emergency communication systems are in close proximity such as in apartment buildings.

15. An emergency communication system according to claim 14 wherein said encoder has circuitry to utilize digital addressing to provide a unique signal transmission address from said pendant to said base unit.

16. An emergency communication system according to claim 1 further including a pendant slide switch connected to said pendant circuitry that is operative to de-energize and energize said pendant circuitry upon manual activation.

17. An emergency communication system according to claim 1 wherein said pendant circuitry further includes a means for producing a pendent perceptible output in response to said pendent circuitry being energized.

18. An emergency communication system according to claim 17 wherein said pendent perceptible output is a visual display.

19. An emergency communication system according to claim 17 wherein said pendent perceptible output is an audible display.

20. An emergency communication system according to claim 1 wherein said pendant electrical power supply is a battery.

21. An emergency communication system according to claim 1 wherein said pendant is contained within a common housing that is adapted to be in the possession of the emergency caller at all times.

22. An emergency communication system according to claim 21 wherein said pendent housing further includes operating instruction indicia visibly disposed on said pendent housing.

23. An emergency communication system according to claim 21 wherein said pendent housing is adapted to be in the possession of the emergency caller selected from the group consisting essentially of a waist belt clip, a necklace, a bracelet, a key chain, and a pocket chain.

24. An emergency communication system according to claim 1 further including pulse width modulation circuitry in said pendant to provide consistent signal transmission strength with varying volume voice input from the emergency caller into said microphone.

25. A method of initializing and providing a functional conformation of an emergency communications system that includes a base unit and a wireless remote personal pendant without the use of an emergency response operator, comprising the steps of:
(a) connecting said base unit into a telephone system;
(b) locating said wireless remote personal pendant at a maximum operational distance from said base unit;
(c) activating a pendant momentary switch four consecutive times to send a low frequency signal to said base unit to make said base unit operative to call a pendant 1-800 telephone number for confirming said base and said pendant operation;
(d) adjusting an antenna of said base unit vertically or horizontally or locating said pendant closer to said base unit if the pendent 1-800 telephone number in step (c) is not called; and
(g) deactivating and subsequently activating the pendant to arm the pendant for future emergency communications.

26. A method of initializing and providing a functional conformation of an emergency communications system according to claim 25 including a step of confirming that said base has a slow flashing visual indication after said step of connecting said base unit into the telephone system.

27. A method of initializing and providing a functional conformation of an emergency communications system according to claim 25 including a step of activating a base momentary switch five consecutive times to make said base unit operative to call a base 1-800 telephone number for confirming said base operation after said step of connecting said base unit into the telephone system.

28. A method of initializing and providing a functional conformation of an emergency communications system according to claim 27 including a step of confirming that said base has a fast flashing visual indication after said step of activating a base momentary switch five consecutive times to make said base unit operative to call a base 1-800 telephone number.

29. A method of initializing and providing a functional conformation of an emergency communications system according to claim 25 wherein said step of deactivating and subsequently activating said pendant to arm said pendant for future emergency communications in accomplished by the use of a slide switch.

30. A method of using an emergency communications system that includes a base unit and a wireless remote personal pendant without the use of a 3rd party monitoring service by directly connecting an emergency caller with an emergency response operator, comprising the steps of:
(a) connecting said base unit into a telephone system;
(b) depressing a pendant push button three (3) times during an emergency situation;
(c) activating said pendant into a power on state;
(d) generating a radio frequency transmission from said pendant;
(e) receiving said radio frequency transmission from said pendant to said base;
(f) activating an automatic dialer in said base to place an emergency call; and
(g) initiating one way voice communication from the emergency caller to the emergency response operator.

31. A method of using an emergency communications system according to claim 30 including a step of said base verifying said pendant radio frequency transmission for said base to only place the emergency call when a matching low frequency signal code is transmitted from said pendant to said base.

32. A method of using an emergency communications system according to claim 30 including a step of said base over riding any off hook phone on a telephone line by disconnecting the off hook phone, allowing the emergency call to be placed on said telephone line.

33. A method of using an emergency communications system according to claim 30 wherein said step of initiating one way voice communication from the emergency caller to the emergency response operator can be accomplished without voice communication from the emergency caller by the emergency call being placed to an enhanced nine one one (911) emergency call system wherein the emergency response operator can determine emergency caller's identification and location without voice communication from the emergency caller.
